(19) United States
(12) Patent Application Publication
(10) Pub. No.: US 2025/0317855 A1
(43) Pub. Date: Oct. 9, 2025

(54) TECHNIQUES FOR TRANSMISSION OF MAIN RADIO CONTROL INFORMATION USING LOW-POWER WAKEUP RECEIVER

(71) Applicant: QUALCOMM Incorporated, San Diego, CA (US)

(72) Inventors: Kangqi LIU, San Diego, CA (US); Huilin XU, Temecula, CA (US); Weimin DUAN, San Diego, CA (US); Le LIU, San Jose, CA (US); Gabi SARKIS, San Diego, CA (US)

(21) Appl. No.: 18/630,853

(22) Filed: Apr. 9, 2024

(51) Int. Cl. H04W 52/02; H04W 72/232

(52) U.S. Cl. CPC H04W 52/0235; H04W 72/232

(57) ABSTRACT

Methods, systems, and devices for wireless communications are described. A user equipment (UE) may be configured to use a low-power wakeup receiver (LP-WUR) to monitor for and receive a physical downlink control channel (PDCCH) message when the UE operates in low-power mode. The PDCCH may be indicative that the UE is to switch from use of the LP-WUR to a main radio. After switching to the main radio, the UE may communicate with a network entity via the main radio.

### INTRODUCTION

The following relates to wireless communications that pertain to the transmission of main radio control information using a low-power wakeup receiver (LP-WURs). Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Such communication systems may support a LP-WUR architecture at a network entity.

### SUMMARY

The described techniques relate to improved methods, systems, devices, and apparatuses that support techniques for transmission of main radio control information using a low-power wakeup receiver (LP-WUR). For example, the described techniques may enable a user equipment (UE) that implements an LP-WUR architecture to support wakeup of a main radio at the UE when the UE operates in a low-power mode. When operating in the low-power mode, the UE may utilize a LP-WUR to monitor for a physical downlink control channel message (PDCCH) targeted to the UE. Reception of the PDCCH targeted to the UE may trigger the UE to switch from use of the LP-WUR to a main radio to receive one or more messages from a wireless communications network. The described techniques may reduce false alarm wake ups at a UE, resulting in lower power consumption at the UE and improved communication reliability between the UE and the wireless communications network.

A method for wireless communications by a first network entity is described. The method may include receiving, via a first radio, a physical downlink control channel message that is indicative that the first network entity is to switch from use of the first radio to a second radio, where the first radio is limited with respect to the second radio, switching the second radio to an on state based on receipt, via the first radio, of the physical downlink control channel message, and participating, after the switch, in communication of a data message with a second network entity via the second radio.

A first network entity for wireless communications is described. The first network entity may include one or more memories storing processor executable code, and one or more processors coupled with the one or more memories. The one or more processors may individually or collectively be operable to execute the code to cause the first network entity to receive, via a first radio, a physical downlink control channel message that is indicative that the first network entity is to switch from use of the first radio to a second radio, where the first radio is limited with respect to the second radio, switch the second radio to an on state based on receipt, via the first radio, of the physical downlink control channel message, and participate, after the switch, in communication of a data message with a second network entity via the second radio.

Another first network entity for wireless communications is described. The first network entity may include means for receiving, via a first radio, a physical downlink control channel message that is indicative that the first network entity is to switch from use of the first radio to a second radio, where the first radio is limited with respect to the second radio, means for switching the second radio to an on state based on receipt, via the first radio, of the physical downlink control channel message, and means for participating, after the switch, in communication of a data message with a second network entity via the second radio.

A non-transitory computer-readable medium storing code for wireless communications is described. The code may include instructions executable by one or more processors to receive, via a first radio, a physical downlink control channel message that is indicative that the first network entity is to switch from use of the first radio to a second radio, where the first radio is limited with respect to the second radio, switch the second radio to an on state based on receipt, via the first radio, of the physical downlink control channel message, and participate, after the switch, in communication of a data message with a second network entity via the second radio.

Some examples of the method, first network entities, and non-transitory computer-readable medium described herein may further include operations, features, means, or instructions for receiving, via the first radio and during a first occasion, a low-power wakeup signal, where the physical downlink control channel message may be received based on reception of the low-power wakeup signal and during a second occasion that may be subsequent to the first occasion.

In some examples of the method, first network entities, and non-transitory computer-readable medium described herein, the low-power wakeup signal may be a sub-group common wakeup signal received at a set of multiple network entities and the method, apparatuses, and non-transitory computer-readable medium may include further operations, features, means, or instructions for monitoring, via the second radio and based on detection of the low-power wakeup signal, for a second physical downlink control channel message including a groupcast, a multicast, or a broadcast message, where the second physical downlink control channel message includes a downlink scheduling grant that indicates a set of resources associated with a physical downlink shared channel message, and receiving, via the set of resources, the physical downlink shared channel message, where the physical downlink shared channel message includes a groupcast, a multicast, or a broadcast message.

In some examples of the method, first network entities, and non-transitory computer-readable medium described herein, the physical downlink control channel message may be a first-stage physical downlink control channel message and the method, apparatuses, and non-transitory computer-readable medium may include further operations, features, means, or instructions for receiving, via the second radio, a second-stage physical downlink control channel message, where the second-stage physical downlink control channel message includes a scheduling grant that indicates a first set of resources associated with the data message, and where the data message may be communicated via the first set of resources.

In some examples of the method, first network entities, and non-transitory computer-readable medium described herein, where the second-stage physical downlink control channel message may be received via the second set of resources.

In some examples of the method, first network entities, and non-transitory computer-readable medium described herein, where the data message may be communicated via the first set of resources and the second radio.

In some examples of the method, first network entities, and non-transitory computer-readable medium described herein, the physical downlink control channel message includes a second scheduling grant that indicates a second set of resources for transmission of a feedback message associated with reception of the physical downlink control channel message and the method, apparatuses, and non-transitory computer-readable medium may include further operations, features, means, or instructions for transmitting, to the second network entity, via the second set of resources and the second radio, and subsequent to reception of the physical downlink control channel message, the feedback message.

In some examples of the method, first network entities, and non-transitory computer-readable medium described herein, when the first scheduling grant is an uplink grant, the first set of resources indicated by the first scheduling grant and the second set of resources indicated by the second scheduling grant include a same set of resources and the method, apparatuses, and non-transitory computer-readable medium may include further operations, features, means, or instructions for participating in communication of the data message includes transmission, to the second network entity and via the same set of resources, of a physical uplink shared channel message including the data message and the feedback message.

Some examples of the method, first network entities, and non-transitory computer-readable medium described herein may further include operations, features, means, or instructions for decoding, with the first radio and based on detection of a layer-modulated signal, a first layer of the layer-modulated signal to detect a low-power wakeup signal, and decoding, with the first radio and based on an indication that the first network entity may be associated with a sub-group associated with the low-power wakeup signal, a second layer of the layer-modulated signal to detect the physical downlink control channel message, where the second radio may be switched to the on state further based on an indication that the physical downlink control channel message may be directed to the first network entity.

A method for wireless communication by a network entity is described. The method may include receiving, via a first radio, a low-power wakeup signal, where the first radio is limited with respect to a second radio, and where the second radio is in an off state, monitoring, based on detection of the low-power wakeup signal and via the first radio, for a physical downlink control channel message that is indicative that the network entity is to switch from use of the first radio to the second radio, and maintaining, based on an elapse of a predetermined time period without detection of the physical downlink control channel message, the second radio in the off state.

A network entity for wireless communication is described. The network entity may include one or more memories storing processor executable code, and one or more processors coupled with the one or more memories. The one or more processors may individually or collectively be operable to execute the code to cause the network entity to receive, via a first radio, a low-power wakeup signal, where the first radio is limited with respect to a second radio, and where the second radio is in an off state, monitor, based on detection of the low-power wakeup signal and via the first radio, for a physical downlink control channel message that is indicative that the network entity is to switch from use of the first radio to the second radio, and maintain, based on an elapse of a predetermined time period without detection of the physical downlink control channel message, the second radio in the off state.

Another network entity for wireless communication is described. The network entity may include means for receiving, via a first radio, a low-power wakeup signal, where the first radio is limited with respect to a second radio, and where the second radio is in an off state, means for monitoring, based on detection of the low-power wakeup signal and via the first radio, for a physical downlink control channel message that is indicative that the network entity is to switch from use of the first radio to the second radio, and means for maintaining, based on an elapse of a predetermined time period without detection of the physical downlink control channel message, the second radio in the off state.

A non-transitory computer-readable medium storing code for wireless communication is described. The code may include instructions executable by one or more processors to receive, via a first radio, a low-power wakeup signal, where the first radio is limited with respect to a second radio, and where the second radio is in an off state, monitor, based on detection of the low-power wakeup signal and via the first radio, for a physical downlink control channel message that is indicative that the network entity is to switch from use of the first radio to the second radio, and maintain, based on an elapse of a predetermined time period without detection of the physical downlink control channel message, the second radio in the off state.

In some examples of the method, network entities, and non-transitory computer-readable medium described herein, where the set of multiple network entities include the network entity and where the physical downlink control channel message may be specific to the network entity.

In some examples of the method, network entities, and non-transitory computer-readable medium described herein, where the physical downlink control channel message may be received during a second occasion that may be subsequent to the first occasion.

In some examples of the method, network entities, and non-transitory computer-readable medium described herein, where the second radio may be a main radio of the network entity.

In some examples of the method, network entities, and non-transitory computer-readable medium described herein, the network entity may be a user equipment (UE).

A method for wireless communication by a first network entity for wireless communication is described. The method may include transmitting, to a target second network entity of a set of multiple second network entities, a unicast physical downlink control channel message that is indicative that the target second network entity is to switch from use of a first radio to a second radio, where the first radio is limited with respect to the second radio and scheduling a first set of resources for communication of a data message with the target second network entity.

A first network entity for wireless communication for wireless communication is described. The first network entity for wireless communication may include one or more memories storing processor executable code, and one or more processors coupled with the one or more memories. The one or more processors may individually or collectively be operable to execute the code to cause the first network entity for wireless communication to transmit, to a target second network entity of a set of multiple second network entities, a unicast physical downlink control channel message that is indicative that the target second network entity is to switch from use of a first radio to a second radio, where the first radio is limited with respect to the second radio and schedule a first set of resources for communication of a data message with the target second network entity.

Another first network entity for wireless communication for wireless communication is described. The first network entity for wireless communication may include means for transmitting, to a target second network entity of a set of multiple second network entities, a unicast physical downlink control channel message that is indicative that the target second network entity is to switch from use of a first radio to a second radio, where the first radio is limited with respect to the second radio and means for scheduling a first set of resources for communication of a data message with the target second network entity.

A non-transitory computer-readable medium storing code for wireless communication is described. The code may include instructions executable by one or more processors to transmit, to a target second network entity of a set of multiple second network entities, a unicast physical downlink control channel message that is indicative that the target second network entity is to switch from use of a first radio to a second radio, where the first radio is limited with respect to the second radio and schedule a first set of resources for communication of a data message with the target second network entity.

In some examples of the method, first network entity for wireless communications, and non-transitory computer-readable medium described herein, the unicast physical downlink control channel message may be a low-power physical downlink control channel message.

Some examples of the method, first network entity for wireless communications, and non-transitory computer-readable medium described herein may further include operations, features, means, or instructions for transmitting, to the set of multiple second network entities and during a first occasion, a low-power wakeup signal, where the unicast physical downlink control channel message may be transmitted based on transmission of the low-power wakeup signal and during a second occasion that may be subsequent to the first occasion.

In some examples of the method, first network entity for wireless communications, and non-transitory computer-readable medium described herein, the unicast physical downlink control channel message may be a unicast first-stage physical downlink control channel message and the method, apparatuses, and non-transitory computer-readable medium may include further operations, features, means, or instructions for scheduling a second set of resources for transmission of a unicast second-stage physical downlink control channel message, where the unicast first-stage physical downlink control channel message includes an indication of the second set of resources and transmitting, to the target second network entity and via the second set of resources, the unicast second-stage physical downlink control channel message, where the unicast second-stage physical downlink control channel message includes a scheduling grant that indicates the first set of resources for communication of the data message.

In some examples of the method, first network entity for wireless communications, and non-transitory computer-readable medium described herein, the unicast physical downlink control channel message includes a first scheduling grant that indicates the first set of resources for communication of the data message.

In some examples of the method, first network entity for wireless communications, and non-transitory computer-readable medium described herein, where the unicast physical downlink control channel message includes a second scheduling grant that indicates a second set of resources for a feedback message associated with reception of the unicast first-stage physical downlink control channel message by the target second network entity.

### BRIEF DESCRIPTION OF THE DRAWINGS

FIG. 1 shows an aspect of a wireless communications system that supports techniques for transmission of main radio control information using a low-power wakeup receiver (LP-WUR) in accordance with one or more aspects of the present disclosure.

FIG. 2 shows an aspect of a signal design that supports use of an LP-WUR in a wireless communication system.

FIG. 3 shows an aspect of a signal design that supports techniques for transmission of main radio control information using an LP-WUR in accordance with one or more aspects of the present disclosure.

FIG. 4 shows an aspect of a signal flow that supports techniques for transmission of main radio control information using an LP-WUR in accordance with one or more aspects of the present disclosure.

FIG. 5 shows an aspect of a signal design that supports techniques for transmission of main radio control information using an LP-WUR in accordance with one or more aspects of the present disclosure.

FIG. 6 shows an aspect of a signal flow that supports techniques for transmission of main radio control information using an LP-WUR in accordance with one or more aspects of the present disclosure.

FIG. 7 shows an aspect of a signal design that supports techniques for transmission of main radio control information using an LP-WUR in accordance with one or more aspects of the present disclosure.

FIG. 8 shows an aspect of a signal flow that supports techniques for transmission of main radio control information using an LP-WUR in accordance with one or more aspects of the present disclosure.

FIG. 9 shows an aspect of a signal design that supports techniques for transmission of main radio control information using an LP-WUR in accordance with one or more aspects of the present disclosure.

FIG. 10 shows an aspect of a signal flow that supports techniques for transmission of main radio control information using an LP-WUR in accordance with one or more aspects of the present disclosure.

FIGS. 11 and 12 show block diagrams of devices that support techniques for transmission of main radio control information using an LP-WUR in accordance with one or more aspects of the present disclosure.

FIG. 13 shows a block diagram of a communications manager that supports techniques for transmission of main radio control information using an LP-WUR in accordance with one or more aspects of the present disclosure.

FIG. 14 shows a diagram of a system including a device that supports techniques for transmission of main radio control information using an LP-WUR in accordance with one or more aspects of the present disclosure.

FIGS. 15 and 16 show block diagrams of devices that support techniques for transmission of main radio control information using an LP-WUR in accordance with one or more aspects of the present disclosure.

FIG. 17 shows a block diagram of a communications manager that supports techniques for transmission of main radio control information using an LP-WUR in accordance with one or more aspects of the present disclosure.

FIG. 18 shows a diagram of a system including a device that supports techniques for transmission of main radio control information using an LP-WUR in accordance with one or more aspects of the present disclosure.

FIGS. 19 through 21 show flowcharts illustrating methods that support techniques for transmission of main radio control information using an LP-WUR in accordance with one or more aspects of the present disclosure.

### DETAILED DESCRIPTION

Various aspects of the present disclosure relate to a wireless communication device, such as a user equipment (UE), that implements a low-power wakeup receiver (LP-WUR) architecture. The UE that implements the LP-WUR architecture may utilize a LP-WUR to monitor for and receive, from a network entity, such as a base station, one or more physical downlink control channel (PDCCH) messages to support wake up of a main radio at the UE when the UE operates in a low-power mode. For instance, some wireless communication systems may support the use of a LP-WUR at a UE as hardware configured for low-power wakeup signal (LP-WUS) monitoring. As compared to a conventional wireless transceiver, also referred to as a main radio (MR), the LP-WUR may implement a simpler hardware design, resulting in lower operational power. Accordingly, use of such LP-WURs may substantially reduce overall power consumption at the UE.

In radio resource control (RRC) idle and inactive modes or in an RRC connected state where the UE is in a light or deep sleep, the UE may turn off the main radio and switch to the LP-WUR to operate in a low-power mode in order to save power. In this low-power mode, the UE may use the LP-WUR to monitor for paging early indications (PEI), such as LP-WUSs, from a network entity that may serve as an indication of an upcoming PDCCH message. Accordingly, when one or more data messages, such as one or more physical uplink or downlink shared channel (PxSCH) messages, need to be communicated to or from the UE, the UE may first receive an LP-WUS from the network entity. In conventional wireless communications systems, the LP-WUS may trigger the UE to wake up (e.g., to turn on the MR) to monitor for the PDCCH message. The PDCCH may, in turn, signal or schedule resources for communicating the one or more PxSCH messages. However, although the PDCCH and upcoming PxSCH messages may be targeted to a specific UE, the LP-WUS may be designed as a group or sub-group common signal that triggers all of the UEs in a given group or sub-group to wake up. As a result, the LP-WUS may trigger a false alarm wake up at those UEs for whom the PDCCH and upcoming PxSCH is not targeted. When the quantity of UEs in the cell is large, the false alarm wake up rate may be high as the number of UEs in each group or sub-group may be relatively large. Further, the network entity that transmits the LP-WUS may be unaware of whether the targeted UE has been successfully triggered by LP-WUS to wake up until the network entity receives a PxSCH message (e.g., receives a PUSCH message) or the feedback of the PxSCH message (e.g., feedback for a PDSCH message) from the UE, which may result in latency at the UE.

Accordingly, aspects described herein may serve to reduce the false alarm wakeup rate and to provide the network entity with an earlier indication that the target UE was successfully awoken by the LP-WUS, thereby also reducing latency at the UE. In accordance with aspects of this disclosure, wireless communication systems that support UEs implementing the LP-WUR architecture may support use of the LP-WUS to trigger monitoring for a PDCCH using a LP-WUR of the UE instead of using a main radio of the UE. In such cases, after reception of a group or sub-group common LP-WUS at the UE, the UE may be triggered to utilize its LP-WUR to monitor for an PDCCH targeted to the UE. In some cases, due to the low complexity nature of the LP-WUR, the UE-specific PDCCH may be a LP-PDCCH to support detection by the LP-WUR. Upon reception of the LP-PDCCH, the UE may determine whether the LP-PDCCH is targeted to itself. If the LP-PDCCH is targeted to the UE, the UE may then turn on its main radio to transmit or receive a PxSCH message or, in some cases, to first receive a second-stage PDCCH scheduling the PxSCH. Further, in some cases, prior to communicating the PxSCH, the UE may transmit an LP-PDCCH acknowledgement message (e.g., an ACK transmission) to the network entity to acknowledge successful reception of the LP-PDCCH and to indicate that the UE has turned on its main radio. On the other hand, if the LP-PDCCH is not targeted to the UE, the UE may not switch to its main radio and may continue to monitor for any subsequent LP-WUSs or LP-PDCCHs using its LP-WUR. The described techniques may enable a reduction in a false alarm wakeup rate and latency within the wireless communications system.

Aspects of the disclosure are initially described in the context of wireless communications systems. Aspects of the disclosure are further illustrated by and described with reference to apparatus diagrams, system diagrams, and flowcharts that relate to techniques for transmission of main radio control information using an LP-WUR.

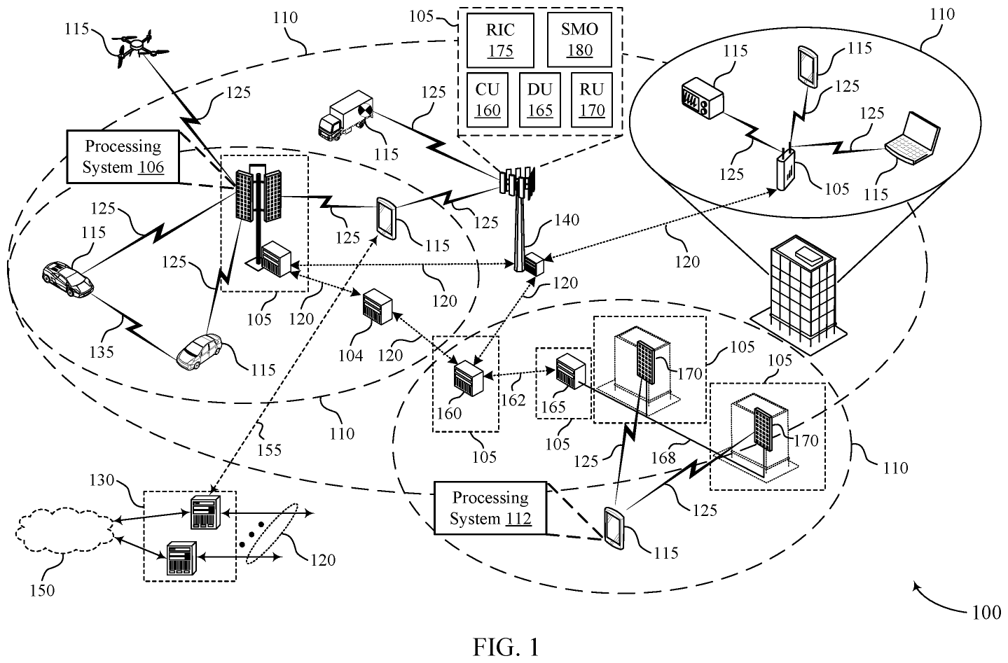

FIG. 1 shows an aspect of a wireless communications system 100 that supports techniques for transmission of main radio control information using an LP-WUR in accordance with one or more aspects of the present disclosure. The wireless communications system 100 may include one or more devices, such as one or more network devices (e.g., network entities 105), one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various aspects, a network entity 105 may be referred to as a network element, a mobility element, a radio access network (RAN) node, or network equipment, among other nomenclature. In some aspects, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some aspects, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some aspects, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other aspects or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some aspects, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some aspects, a network entity 105 (e.g., a base station 140, an RU 170) may be movable and therefore provide communication coverage for a moving coverage area, such as the coverage area 110. In some aspects, coverage areas 110 (e.g., different coverage areas) associated with different technologies may overlap, but the coverage areas 110 (e.g., different coverage areas) may be supported by the same network entity (e.g., a network entity 105). In some other aspects, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some aspects, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to one or more of the UEs 115 in the group. In some aspects, a network entity 105 may facilitate the scheduling of resources for D2D communications. In some other aspects, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In accordance with aspects described herein, a UE 115 may be configured with a LP-WUR. The UE 115 may utilize the LP-WUR to monitor for and receive one or more signals when the UE 115 operates in a low-power mode. For example, the UE 115 may utilize the LP-WUR to monitor for and receive a physical downlink control channel (PDCCH). In some cases, the PDCCH may be a LP-PDCCH or a first-stage PDCCH. The PDCCH may be indicative that the UE 115 is to switch from use of the LP-WUR to a main radio to receive a second-stage PDCCH and to additionally, or alternatively, communicate a PxSCH.

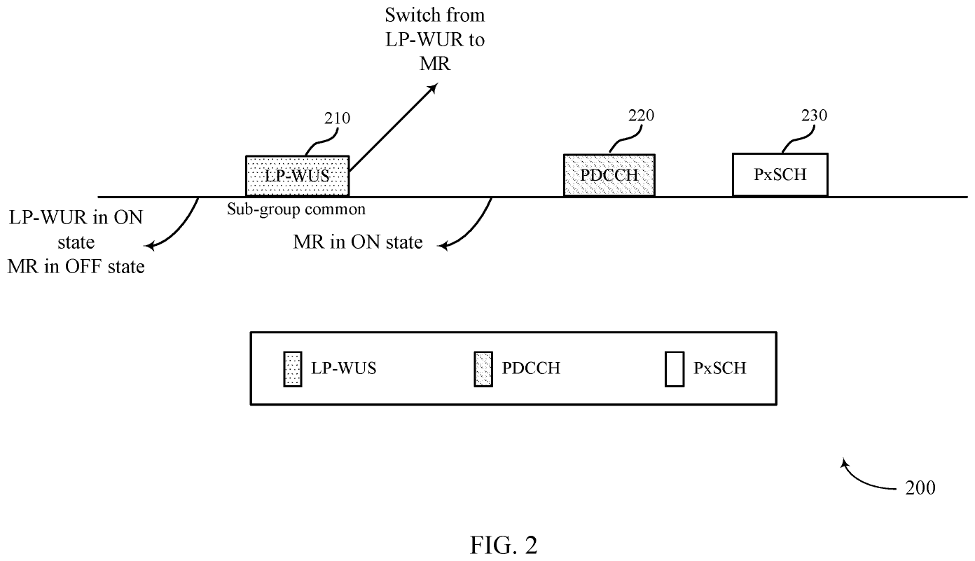

FIG. 2 shows an aspect of a signaling design 200 that supports use of an LP-WUR in a wireless communications system. In some aspects, signaling design 200 may be implemented by aspects of the wireless communications system 100, as described with reference to FIG. 1. For example, a UE 115, a network entity 105, or a combination thereof, may be configured to operate in accordance with the signaling design 200. In some aspects, the UE 115 may be configured with a LP-WUR, and the signaling design 200 may support the use of the LP-WUR at the UE 115 as the hardware for LP-WUS monitoring. The LP-WUR may implement a lower-complexity hardware design relative to that of a main radio operating at the UE 115, resulting in reduced power consumption at the UE 115.

In conventional wireless communications systems, the network entity 105 may transmit, to the UE 115, a LP-WUS 210. The UE 115 may monitor for the LP-WUS 210 using its LP-WUR. Reception of the LP-WUS 210 may trigger the UE 115 to wake up, such as to switch from use of its LP-WUR to use of its main radio to monitor for an upcoming PDCCH message 220. The UE 115 may blind-decode the PDCCH message 220 to receive a grant scheduling resources for transmitting or receiving a PxSCH message 230 targeted for (or received from) a specific UE, such as for the UE 115. The LP-WUS 210 may be a group or sub-group common signal that triggers all of the UEs, including the UE 115, in a given group or sub-group to wake up. As a result, the LP-WUS 210 may trigger a false alarm wake up at those UEs in the group or sub-group for whom the PDCCH message 220 and upcoming PxSCH message 230 is not targeted. When the quantity of UEs in the cell serving the group or sub-group signaled by the LP-WUS 210 is large, the false alarm wake up rate may be high as the number of UEs in the group or sub-group may be relatively large. Further, the network entity 105 may be unaware of whether the UE 115 has been successfully triggered by LP-WUS 210 to wake up its main radio until the network entity 105 receives the PxSCH message 230 (e.g., receives a PUSCH message) from the UE 115 or receives feedback associated with the PxSCH message 230 (e.g., feedback for a PDSCH message) from the UE 115, thus resulting in latency at the UE 115.

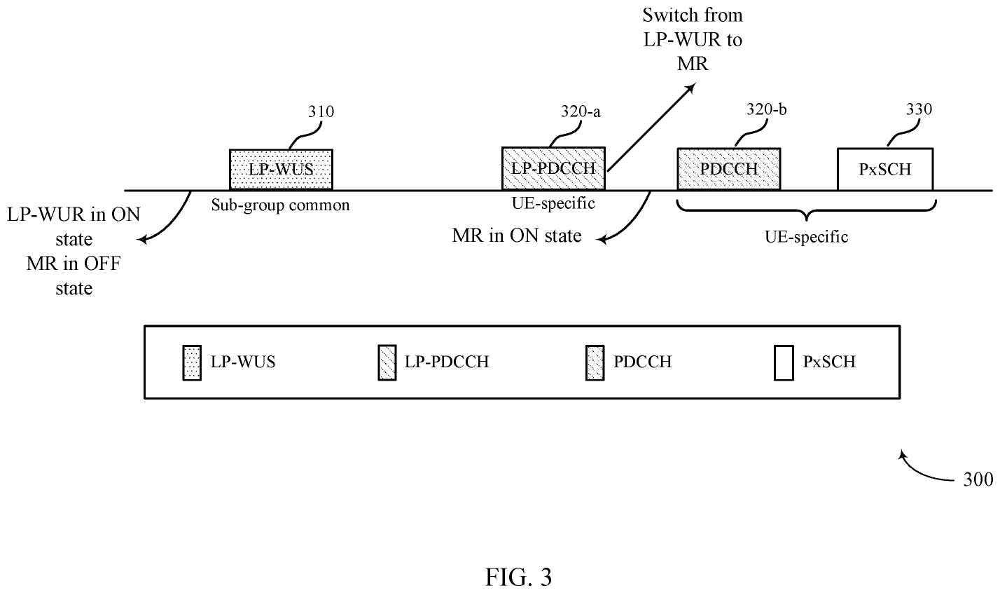

FIG. 3 shows an aspect of a signal design 300 that supports techniques for transmission of main radio control information using an LP-WUR in accordance with one or more aspects of the present disclosure. In some aspects, signal design 300 may be implemented by aspects of the wireless communications system 100, as described with reference to FIG. 1. For example, a UE 115-a, a network entity 105-a, or a combination thereof, may be configured to operate in accordance with the signal design 300. The UE 115-a and the network entity 105-a may be examples of the UE 115 and network entity 105 described with reference to FIG. 1. In some aspects, the UE 115-a may be configured with a LP-WUR, and the signal design 300 may support the use of the LP-WUR at the UE 115-a as the hardware for LP-WUS and LP-PDCCH monitoring. The LP-WUR may implement a lower-complexity hardware design relative to that of a main radio operating at the UE 115-a, resulting in reduced power consumption at the UE 115-a.

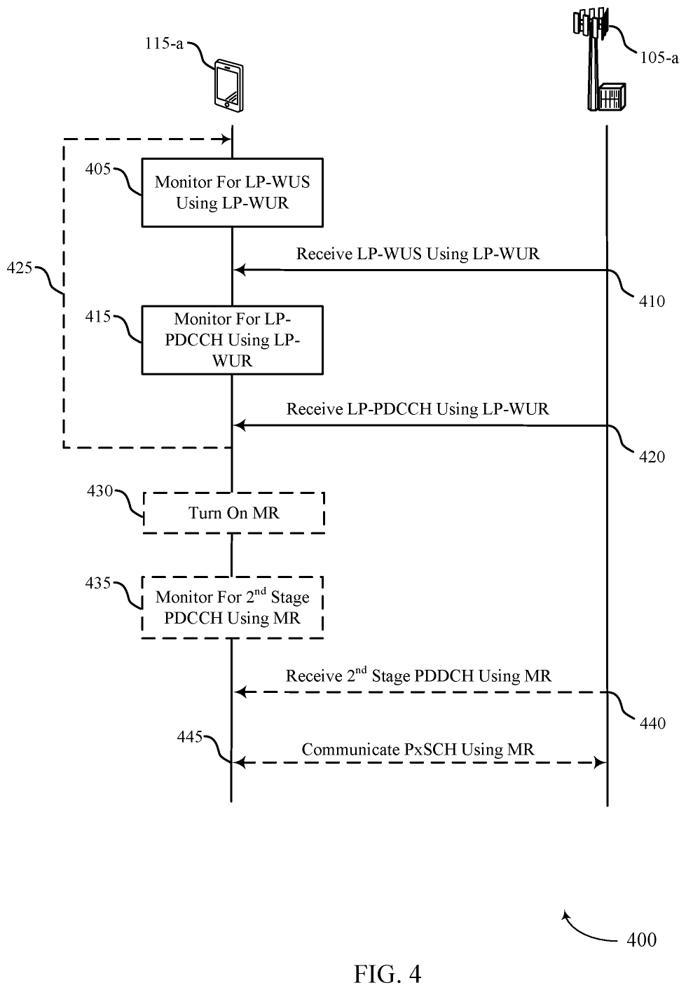

FIG. 4 shows an aspect of a signal flow 400 associated with the signal design 300 of FIG. 3. In some aspects, the signal flow 400 may implement or be implemented by aspects of the wireless communications systems 100 and signal design 300 as described with reference to FIGS. 1 and 3, respectively. The signal flow 400 may illustrate the flow of signals between the UE 115-a and the network entity 105-a. In the following description of the signal flow 400, the communications between the UE 115-a and the network entity 105-a may be transmitted in a different order than the order shown, or the operations performed by the UE 115-a and the network entity 105-a may be performed in different orders or at different times. Some operations may also be omitted from the signal flow 400, and other operations may be added to the signal flow 400. In some aspects, the operations illustrated in signal flow 400 may be performed by hardware (e.g., including circuitry, processing blocks, logic components, and other components), code (e.g., software or firmware) executed by a processor, or any combination thereof. Alternatively, some steps may be performed in a different order than described or might not be performed at all. In some cases, steps may include additional features not mentioned below, or further steps may be added.

Referring to FIGS. 3 and 4, in idle, inactive, or sleep modes, a UE 115-a may turn off its main radio and switch to its LP-WUR to operate in a low-power mode in order to save power. The UE 115-a may use the LP-WUR to monitor for one or more LP-WUSs and one or more LP-PDCCH messages.

At step 405, the UE 115-a may monitor for the LP-WUS 310 using a LP-WUR. For instance, the network entity 105-a may pre-configure one or more occasions for receiving LP-WUSs, and the UE 115-a may monitor one or more of the LP-WUS occasions for the LP-WUS 310. The LP-WUS occasions may be signaled to the UE 115-a via RRC signaling including RRC configuration information at a time when the main radio is on.

At step 410, the network entity 105-a may transmit and the UE 115-a may receive, using the LP-WUR, the LP-WUS 310 during one of the LP-WUS occasions. The LP-WUS 310 may be a group common or sub-group common LP-WUS and the UE 115-a may be a member of the group or sub-group of UEs selected to wake up to potentially communicate an upcoming PxSCH message 330. Accordingly, reception of the LP-WUS 310 may be an indication for the UE 115-a to begin to monitor one or more occasions for a LP-PDCCH message 320-a, which may be used to select the particular UE to communicate the upcoming PxSCH message 330. In some cases, the LP-WUS 310 may indicate a first timing offset between the LP-WUS 310 and a timing resource allocated to the LP-PDCCH message 320-a. In other cases, the first timing offset may be pre-configured (such as at a time when the main radio is on) at the UE 115-a by the network entity 105-a via RRC signaling including RRC configuration information. The first timing offset may be dependent on capabilities of the UE 115-a. For instance, the network entity 105-a may configure the timing offset for the UE 115-a based on the time it takes for the UE 115-a to wake up its main radio. Accordingly, different UEs with different capabilities may be configured with different timing offsets.

At step 415, the UE 115-a may monitor one or more LP-PDCCH occasions for the LP-PDCCH message 320-a using the LP-WUR. In some cases, the UE 115-a may begin monitoring for the LP-PDCCH message 320-a after the first timing offset. In some cases, the network entity 105-b may preconfigure (such as at a time when the main radio is on) an indication that enables or disables detection of LP-PDCCH messages by the UE 115-a using the LP-WUR. The indication may be signaled to the UE 115-a via RRC signaling including RRC configuration information. The one or more LP-PDCCH occasions messages may also be pre-configured (such as at a time when the main radio is on) by the network entity 105-a and signaled to the UE 115-a via RRC signaling including RRC configuration information. In some cases, the LP-PDCCH occasions may be configured together with the LP-WUS occasions. In other cases, the LP-PDCCH occasions and the LP-WUS occasions may be configured via separate configurations (e.g., multiple RRC configurations). In some cases, the LP-PDCCH occasions may be shared or UE-specific. When shared, UE 115-a may differentiate or identify the LP-PDCCH using UE-specific radio network temporary identifier (RNTI) or other identifier associated with the UE 115-a. When UE-specific, several UEs may be configured with same the LP-PDCCH occasions but overlapping UEs may be associated with different groups or sub-group. In this case, when a particular group or sub-group ID is indicated by LP-WUS to wake up, only the UEs in the indicated group or sub-group will have wake and access the specific LP-PDCCH occasion without overlapping occurring.

At step 420, the network entity 105-a may transmit and the UE 115-a may receive, using the LP-WUR, the LP-PDCCH message 320-a during one of the LP-PDCCH occasions and/or after the first timing offset. The LP-PDCCH message 320-a may be a UE-specific PDCCH message. For instance, the LP-PDCCH message 320-a may be a unicast message targeted to a specific UE among the UEs in the group or sub-group selected to wake up by the LP-WUS 310. The LP-PDCCH message 320-a may serve as an indication that the targeted UE should wake up its main radio to receive the upcoming PxSCH message 330. In some cases, the LP-PDCCH message 320-a may be transmitted as an on-off keying (OOK) waveform, which may be similar to an LP-WUS. In this case, the LP-PDCCH sequence may be encoded and then modulated using OOK. Alternatively, the LP-PDCCH message 320-a may be transmitted as an OFDM waveform. In such cases, the UE 115-a may use the LP-WUR to decode the payload of the LP-PDCCH message 320-a, or to buffer the signal and turn on the main radio to decode the payload of the LP-PDCCH message 320-a.

Upon receiving the LP-PDCCH message 320-a, the UE 115-a may decode the LP-PDCCH message 320-a to determine whether the LP-PDCCH message 320-a is directed to the UE 115-a. In some cases, the LP-PDCCH message 320-a may further include a grant scheduling resources for the upcoming PxSCH message 330. In other cases, the LP-PDCCH message 320-a might not include a grant scheduling resources for the upcoming PxSCH message 330 and, instead, may include a grant scheduling resources for a second PDCCH message, such as second-stage PDCCH message 320-b.

For instance, if a size of a downlink control information (DCI) payload exceeds a threshold size and is larger than can be carried by the LP-PDCCH message 320-a, the network entity 105-a may partition the DCI payload and cause the DCI payload to be carried by multiple PDCCH messages. In this case, the LP-PDCCH message 320-a may carry a first portion of the DCI payload and may be considered a first-stage LP-PDCCH message, and a remaining portion of the DCI payload may be carried by the second-stage PDCCH message 320-b. When the DCI payload is partitioned in this manner, the first-state LP-PDCCH message 330-a may include a grant scheduling resources for the second-stage PDCCH message 320-b and the second-stage PDCCH message 320-b may carry the grant scheduling resources for the upcoming PxSCH message 330. In some cases, the LP-PDCCH message 320-a may indicate a second timing offset between the LP-PDCCH message 320-a and a timing resource allocated to the second-stage PDCCH message 320-b. In some cases, the second timing offset may be pre-configured (such as at a time when the main radio is on) at the UE 115-a by the network entity 105-a via RRC signaling including RRC configuration information. In some cases, the second timing offset may be dependent on capabilities of the UE 115-a, such as a time to turn on the main radio.

When the DCI payload is not partitioned (e.g., the payload is of a size that can be fully carried by the LP-PDCCH message 320-a), the LP-PDCCH message 320-a may carry the grant scheduling resources for the upcoming PxSCH message 330. In some cases, the LP-PDCCH message 320-a may indicate a third timing offset between the LP-PDCCH message 320-a and a timing resource allocated to the PxSCH message 330. In some cases, the third timing offset may be pre-configured (such as at a time when the main radio is on) at the UE 115-a by the network entity 105-a via RRC signaling including RRC configuration information. In some cases, the third timing offset may be dependent on capabilities of the UE 115-a, such as a time to turn on the main radio. In some cases, the UE 115-a may report, to the network entity 105-a, its capabilities of a timing gap between an LP-PDCCH message and a PxSCH message. The minimum timing gap associated with the LP-PDCCH may be different from that of a PDCCH received via a main radio.

Further, when the DCI payload is not partitioned, the second-stage PDCCH message 320-b may not need to be sent to the UE 115-a by the network entity 105-a. This may result in further power savings over conventional wireless communications systems, in which after waking up the main radio the UE may have to blind decode a PDCCH to receive a scheduling grant for an upcoming PxSCH. Such blind decoding consumes significant power and, thus, avoiding such blind-decoding may result in a significant power savings at the UE 115-a.

At step 425, if the UE 115-a determines that the LP-PDCCH message 320-a is not targeted to the UE 115-a, the UE 115-a may continue to monitor for further LP-WUSs using the LP-WUR. That is, the UE 115-a may not unnecessarily turn on its main radio.

At step 430, if the UE 115-a determines that the LP-PDCCH message 320-a is targeted to the UE 115-a, the UE 115-a may then turn on its main radio to begin monitoring for the second-stage PDCCH message 320-b (if scheduled by the LP-PDCCH message 320-a) or for the upcoming PxSCH message 330 (if scheduled by the LP-PDCCH message 320-a).

At step 435, if the LP-PDCCH message 320-a was targeted to the UE 115-a and if the LP-PDCCH message 320-a included a scheduling grant for the second-stage PDCCH message 320-b, then the UE 115-a may use its main radio to monitor the scheduled resources for the second-stage PDCCH message 320-b.

At step 440, if the LP-PDCCH message 320-a included a scheduling grant for the second-stage PDCCH message 320-b, the network entity 105-a may transmit and the UE 115-a may receive, using the main radio, the second-stage PDCCH message 320-b. The UE 115-a may decode the second-stage PDCCH message 320-b to receive the scheduling grant for the upcoming PxSCH message 330. Further, unlike conventional wireless communications systems, here, the UE 115-a may avoid the need to blind-decode the second-stage PDCCH message 320-b after waking up the main radio since its location may be provided by the resource allocation included in the LP-PDCCH message 320-a. Avoiding the blind-decoding may result in a significant power savings at the UE 115-a as the blind-decoding may consume significant amounts of power.

At step 445, the UE 115-a may use the main radio to communicate the upcoming PxSCH message 330 (such as transmit a PUSCH message to the network entity 105-a or receive a PDSCH message from the network entity 105-a) using the resources scheduled by either the LP-PDCCH message 320-a or the second-stage PDCCH message 320-b.

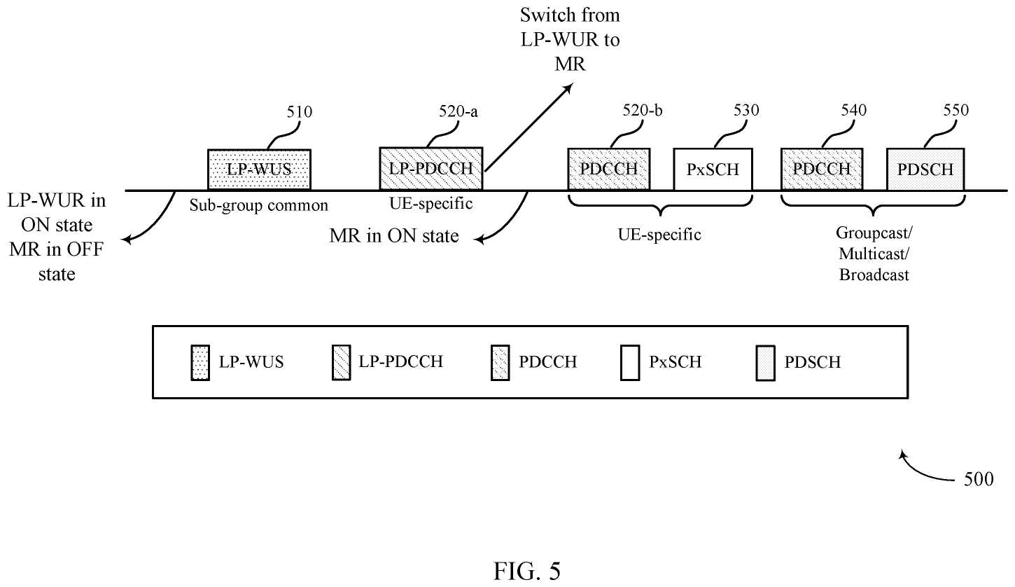

FIG. 5 shows an aspect of a signal design 500 that supports techniques for transmission of main radio control information using an LP-WUR in accordance with one or more aspects of the present disclosure. In some aspects, signal design 500 may be implemented by aspects of the wireless communications system 100, as described with reference to FIGS. 1, or signal design 300, as described with reference to FIGS. 3 and 4. For example, a UE 115-b, a network entity 105-b, or a combination thereof, may be configured to operate in accordance with the signal design 500. The UE 115-b and the network entity 105-b may be examples of the UE 115 and network entity 105 described with reference to FIG. 1 or the UE 115-a and network entity 105-a described with reference to FIGS. 3 and 4. In some aspects, the UE 115-b may be configured with a LP-WUR, and the signal design 500 may support the use of the LP-WUR at the UE 115-b as the hardware for LP-WUS and LP-PDCCH monitoring. The LP-WUR may implement a lower-complexity hardware design relative to that of a main radio operating at the UE 115-b, resulting in reduced power consumption at the UE 115-b.

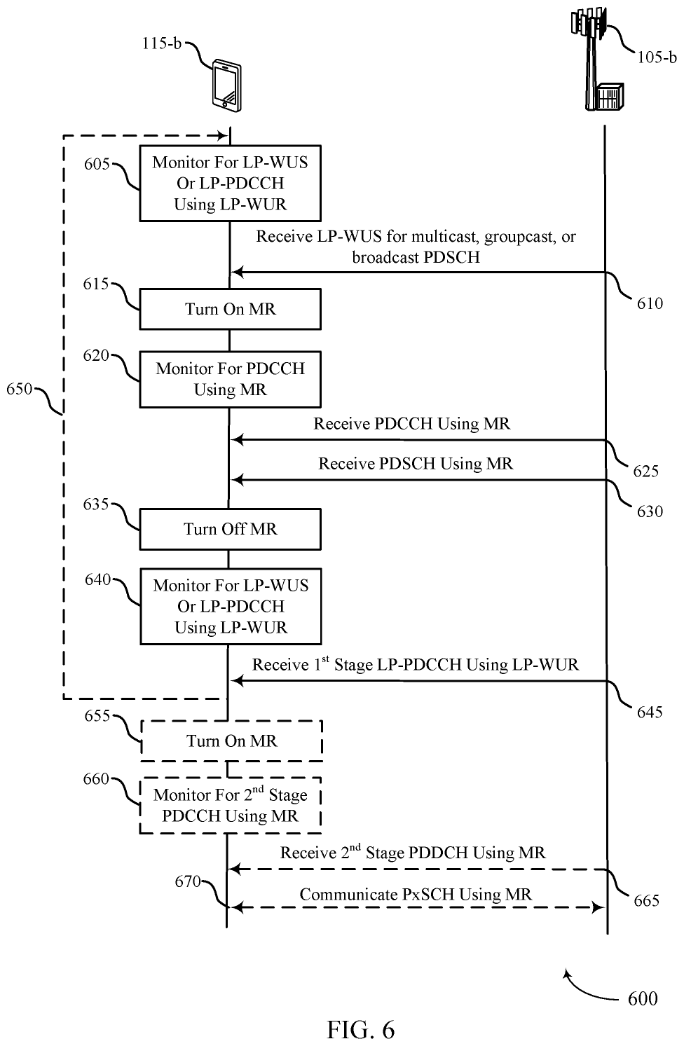

FIG. 6 shows an aspect of a signal flow 600 associated with the signal design 500 of FIG. 5. In some aspects, the signal flow 600 may implement or be implemented by aspects of the wireless communications systems 100 and signal flow 400, as described with reference to FIGS. 1 and 4, respectively. The signal flow 600 may illustrate the flow of signals between the UE 115-b and the network entity 105-b. In the following description of the signal flow 600, the communications between the UE 115-b and the network entity 105-b may be transmitted in a different order than the order shown, or the operations performed by the UE 115-b and the network entity 105-b may be performed in different orders or at different times. Some operations may also be omitted from the signal flow 600, and other operations may be added to the signal flow 600. In some aspects, the operations illustrated in signal flow 600 may be performed by hardware (e.g., including circuitry, processing blocks, logic components, and other components), code (e.g., software or firmware) executed by a processor, or any combination thereof. Alternatively some steps may be performed in a different order than described or might not be performed at all. In some cases, steps may include additional features not mentioned below, or further steps may be added.

Referring to FIGS. 5 and 6, in idle, inactive, or sleep modes, the UE 115-b may turn off its main radio and switch to its LP-WUR to operate in a low-power mode in order to save power. The UE 115-b may use the LP-WUR to monitor for one or more LP-WUSs or one or more LP-PDCCH messages. In this implementation, monitoring for the LP-PDCCH messages may be independent of monitoring for the LP-WUSs.

At step 605, the UE 115-b may monitor for the LP-WUS 510 or for the LP-PDCCH message 520-a using a LP-WUR. For instance, monitoring for the LP-PDCCH message 520-a may be independent of monitoring for the LP-WUS 510. The network entity 105-b may pre-configure one or more occasions for receiving LP-WUSs and one or more occasions for receiving the LP-PDCCH messages, and the UE 115-b may monitor one or more of the LP-WUS occasions for the LP-WUS 510 and one or more of the LP-PDCCH occasions for the LP-PDCCH message 520-a. The LP-WUS occasions and LP-PDCCH occasions may be preconfigured in a manner described with reference to FIGS. 3 and 4.

At step 610, the network entity 105-b may transmit and the UE 115-b may receive, using the LP-WUR, the LP-WUS 510 during one of the LP-WUS occasions. The LP-WUS 510 may be a group common or sub-group common LP-WUS and the UE 115-b may be a member of the group or sub-group of UEs selected to wake up to receive an upcoming groupcast, multicast, or broadcast PDSCH message 550. Accordingly, reception of the LP-WUS 510 may be an indication for the UE 115-b to turn on its main radio to begin to monitor one or more occasions for a groupcast, multicast, or broadcast PDCCH message 540, which may be used to schedule the upcoming groupcast, multicast, or broadcast PDSCH message 550. In some cases, the LP-WUS 510 may indicate a first timing offset between the LP-WUS 510 and a timing resource allocated to the PDCCH message 540. In other cases, the first timing offset may be pre-configured (such as at a time when the main radio is on) at the UE 115-b by the network entity 105-b via RRC signaling including RRC configuration information, such as in a manner described with reference to FIGS. 3 and 4.

At step 615, the UE 115-b may turn off its LP-WUR and turn on its main radio to begin monitoring for the groupcast, multicast, or broadcast PDCCH message 540.

At step 620, the UE 115-b may monitor one or more PDCCH occasions for the groupcast, multicast, or broadcast PDCCH message 540 using the main radio. In some cases, the UE 115-b may begin monitoring for the groupcast, multicast, or broadcast PDCCH message 540 after the first timing offset.

At step 625, the network entity 105-b may transmit and the UE 115-b may receive, using the main radio, the groupcast, multicast, or broadcast PDCCH message 540 during one of the PDCCH occasions and/or after the first timing offset. The UE 115-b may decode the groupcast, multicast, or broadcast PDCCH message 540 to receive a grant scheduling resources for the upcoming the groupcast, multicast, or broadcast PDSCH message 550.

At step 630, the network entity 105-b may transmit and the UE 115-b may receive, using the main radio, the groupcast, multicast, or broadcast PDSCH message 550.

At step 635, after some period of time the UE 115-b may return to an idle, inactive or sleep state and turn off its main radio and turn on its LP-WUR to operate in a low-power mode.

At step 640, the UE 115-b may resume monitoring for a LP-WUS or an LP-PDCCH message using the LP-WUR. For example, the UE 115-b may monitor one or more of the LP-WUS occasions for an LP-WUS 510 (such as an additional LP-WUS 510) and one or more of the LP-PDCCH occasions for the LP-PDCCH message 520-a. Step 640 may be similar to step 605.

At step 645, the network entity 105-b may transmit and the UE 115-b may receive, using the LP-WUR, the LP-PDCCH message 520-a during one of the LP-PDCCH occasions. The LP-PDCCH message 520-a may be a UE-specific PDCCH message. For instance, the LP-PDCCH message 520-a may be a unicast message targeted to a specific UE. The LP-PDCCH message 520-a may serve as an indication that the targeted UE should wake up its main radio to receive the upcoming PxSCH message 530. Accordingly, upon receiving the LP-PDCCH message 520-a, the UE 115-b may decode the LP-PDCCH message 520-a to determine whether the LP-PDCCH message 520-a is directed to the UE 115-b. In some cases, the LP-PDCCH message 520-a may further include a grant scheduling resources for the upcoming PxSCH message 530. In other cases, such as when the DCI payload is partitioned into multiple messages and the LP-PDCCH message 520-a is a first-stage LP-PDCCH, the LP-PDCCH message 520-a might not include a grant scheduling resources for the upcoming PxSCH message 530. Instead, the LP-PDCCH message 520-a may include a grant scheduling resources for a second-stage PDCCH message 520-b.

In some cases, the LP-PDCCH message 520-a may indicate a second timing offset between the LP-PDCCH message 520-a and a timing resource allocated to the second-stage PDCCH message 520-b, or a third timing offset between the LP-PDCCH message 520-a and a timing resource allocated to the PxSCH message 530. The second and third timing offsets may be pre-configured in the manner described with respect to FIGS. 3 and 4. Further, the UE 115-b may report, to the network entity 105-b, its capabilities of a timing gap between an LP-PDCCH message and a PxSCH message. The LP-PDCCH message 520-a may be similar to the LP-PDCCH message 320-a of FIG. 3.

At step 650, if the UE 115-b determines that the LP-PDCCH message 520-a is not targeted to the UE 115-b, the UE 115-a may continue to monitor for further LP-WUSs or LP-DCCHs using the LP-WUR.

At step 655, if the UE 115-b determines that the LP-PDCCH message 520-a is targeted to the UE 115-b, the UE 115-b may then turn on its main radio to begin monitoring for the second-stage PDCCH message 520-b (if scheduled by the LP-PDCCH message 520-a) or for the upcoming message PxSCH message 530 (if scheduled by the LP-PDCCH message 520-a).

At step 660, if the LP-PDCCH message 520-a was targeted to the UE 115-b and if the LP-PDCCH message 520-a included a scheduling grant for the second-stage PDCCH message 520-b, then the UE 115-b may use its main radio to monitor the scheduled resources for the second-stage PDCCH message 520-b.

At step 665, if the LP-PDCCH message 520-a included a scheduling grant for the second-stage PDCCH message 520-b, the network entity 105-b may transmit and the UE 115-b may receive, using the main radio, the second-stage PDCCH message 520-b. The UE 115-b may decode the second-stage PDCCH message 520-b to receive the scheduling grant for the upcoming PxSCH message 530.

At step 670, the UE 115-b may use the main radio to communicate the PxSCH message 530 (such as transmit a PUSCH message to the network entity 105-b or receive a PDSCH message from the network entity 105-b) using the resources scheduled by either the LP-PDCCH message 520-a or the second-stage PDCCH message 520-b.

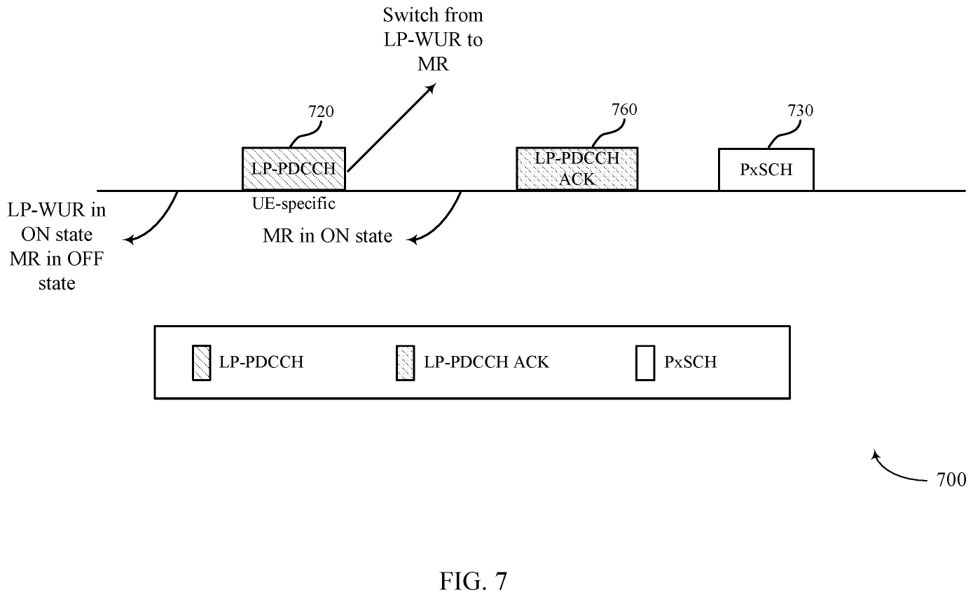

FIG. 7 shows an aspect of a signal design 700 that supports techniques for transmission of main radio control information using an LP-WUR in accordance with one or more aspects of the present disclosure. In some aspects, signal design 700 may be implemented by aspects of the wireless communications system 100, as described with reference to FIGS. 1, or signal designs 300 and 500, as described with reference to FIGS. 3, 4, 5, and 6. For example, a UE 115-c, a network entity 105-c, or a combination thereof, may be configured to operate in accordance with the signal design 700. The UE 115-c and the network entity 105-c may be examples of the UE 115 and network entity 105 described with reference to FIG. 1, the UE 115-a and network entity 105-a described with reference to FIGS. 3 and 4, or the UE 115-b and network entity 105-b described with reference to FIGS. 5 and 6. In some aspects, the UE 115-c may be configured with a LP-WUR, and the signal design 700 may support the use of the LP-WUR at the UE 115-c as the hardware for LP-WUS and LP-PDCCH monitoring. The LP-WUR may implement a lower-complexity hardware design relative to that of a main radio operating at the UE 115-c, resulting in reduced power consumption at the UE 115-c.

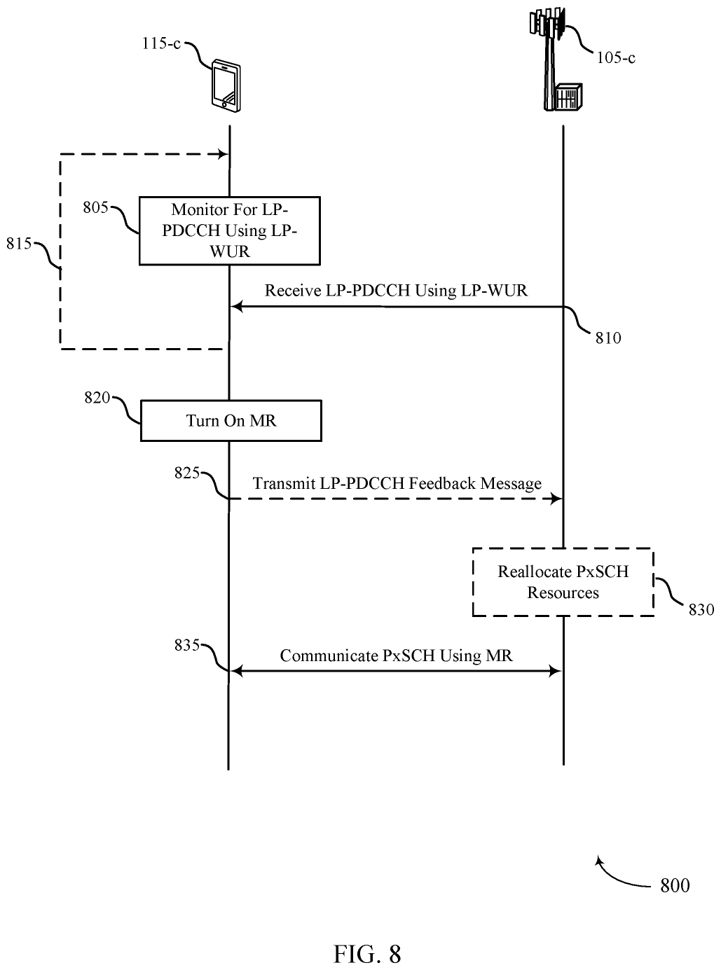

FIG. 8 shows an aspect of a signal flow 800 associated with the signal design 700 of FIG. 7. In some aspects, the signal flow 800 may implement or be implemented by aspects of the wireless communications systems 100 and signal flows 400 and 600 as described with reference to FIGS. 1, 4, and 6, respectively. The signal flow 800 may illustrate the flow of signals between the UE 115-c and the network entity 105-c. In the following description of the signal flow 800, the communications between the UE 115-c and the network entity 105-c may be transmitted in a different order than the order shown, or the operations performed by the UE 115-c and the network entity 105-c may be performed in different orders or at different times. Some operations may also be omitted from the signal flow 800, and other operations may be added to the signal flow 800. In some aspects, the operations illustrated in signal flow 800 may be performed by hardware (e.g., including circuitry, processing blocks, logic components, and other components), code (e.g., software or firmware) executed by a processor, or any combination thereof. Alternatively, some steps may be performed in a different order than described or might not be performed at all. In some cases, steps may include additional features not mentioned below, or further steps may be added.

Referring to FIGS. 7 and 8, in idle, inactive, or sleep modes, the UE 115-c may turn off its main radio and switch to its LP-WUR to operate in a low-power mode in order to save power. The UE 115-c may use the LP-WUR to monitor for one or more LP-PDCCH messages. In this implementation, monitoring for the LP-PDCCH messages may be independent of monitoring for an LP-WUSs.

At step 805, the UE 115-c may monitor for a LP-PDCCH message 720 using a LP-WUR. For instance, monitoring for the LP-PDCCH message 720 may be independent of monitoring for an LP-WUS. The network entity 105-b may pre-configure one or more occasions for receiving LP-PDCCH messages, and the UE 115-b may monitor one or more of the LP-PDCCH occasions for the LP-PDCCH message 720. The LP-PDCCH occasions may be preconfigured in a manner described with reference to FIGS. 3 and 4.

At step 810, the network entity 105-c may transmit and the UE 115-c may receive, using the LP-WUR, the LP-PDCCH message 720 during one of the LP-PDCCH occasions. The LP-PDCCH message 720 may be a UE-specific PDCCH message. For instance, the LP-PDCCH message 720 may be a unicast message targeted to a specific UE. The LP-PDCCH message 720 may serve as an indication that the targeted UE should wake up its main radio to receive an upcoming PxSCH message 730. Accordingly, upon receiving the LP-PDCCH message 720, the UE 115-c may decode the LP-PDCCH message 720 to determine whether the LP-PDCCH message 720 is directed to the UE 115-c.

The LP-PDCCH message 720 may include a grant scheduling resources for the upcoming PxSCH message 730. In other cases, such as when the DCI payload is partitioned into multiple messages and the LP-PDCCH message 720 is a first-stage LP-PDCCH, the LP-PDCCH message 720 might not include a grant scheduling resources for the upcoming PxSCH message 730 and, instead, may include a grant scheduling resources for a second-stage PDCCH message (in this case the second-stage PDCCH message may include the grant scheduling resources for the upcoming PxSCH message 730). The LP-PDCCH message 720 may be similar to the LP-PDCCH message 320-a of FIG. 3 or the LP-PDCCH message 520-a of FIG. 5, except that in addition to a first grant scheduling resources for a second-stage LP-PDCCH or the upcoming PxSCH message 730, the LP-PDCCH message 720 may additionally include a second grant scheduling resources for a feedback message associated with the LP-PDCCH message 720, such as an LP-PDCCH ACK message 760. The LP-PDCCH ACK message 760 may serve to acknowledge successful receipt of the LP-PDCCH message 720 by the UE 115-c. In some cases, the UE 115-c may report, to the network entity 105-c, its capabilities of a timing gap between an LP-PDCCH message and a LP-PDCCH ACK message. In some cases, when the first grant is an uplink grant (such as when the PxSCH message 730 is a PUSCH message), the first grant and the second grant may be a combined grant that allocates resources for a single PUSCH message, where the LP-PDCCH ACK message 760 is piggybacked on the PxSCH message 730.

At step 815, if the UE 115-c determines that the LP-PDCCH message 720 is not targeted to the UE 115-c, the UE 115-a may continue to monitor for further LP-LP-DCCHs (or WUSs) using the LP-WUR.

At step 820, if the UE 115-b determines that the LP-PDCCH message 720 is targeted to the UE 115-c, the UE 115-c may then turn on its main radio to begin monitoring for the second-stage PDCCH (if scheduled by the LP-PDCCH message 520-a) or may directly monitor for the upcoming PxSCH message 730 (if scheduled by the LP-PDCCH message 720).

At step 825, the UE 115-c may transmit and the network entity 105-c may receive the LP-PDCCH ACK message 760 to the network entity 105-c. The LP-PDCCH ACK message 760 may serve to acknowledge successful receipt of the LP-PDCCH message 720 by the UE 115-c. In some cases, the UE 115-c might not transmit the LP-PDCCH ACK message 760, such as if the LP-PDCCH message 720 is not successfully received at the UE 115-c.

At step 830, if the network entity 105-c does not receive the LP-PDCCH ACK message 760 from the UE 115-c within a predetermined period of time, the network entity 105-c may reschedule the resources allocated to the PxSCH message 730 for other purposes. In this way resource efficiency may be enhanced when the UE 115-c fails to be indicated to wake up. Additionally, in some cases, if the network entity 105-c does not receive the LP-PDCCH ACK message 760 from the UE 115-c within the predetermined period of time, the network entity 105-c may fall back to a conventional LP-WUS procedure and the UE 115-c may receive further PDCCHs using the main radio of the UE 11-c.

At step 835, the UE 115-c may use the main radio to communicate the PxSCH message 730 (such as transmit a PUSCH message to the network entity 105-c or receive a PDSCH message from the network entity 105-c) using the resources scheduled by the LP-PDCCH message 720 (or in some cases a second-stage PDCCH message). In cases where the LP-PDCCH message 720 included the combined grant (allocating resources for a single PUSCH message when the PxSCH message 730 is a PUSCH message) and the PxSCH message 730 is a PUSCH message, the LP-PDCCH ACK message 760 and the PxSCH message 730 may be transmitted using the same resources, such that the LP-PDCCH ACK message 760 may be piggybacked on the PxSCH message 730.

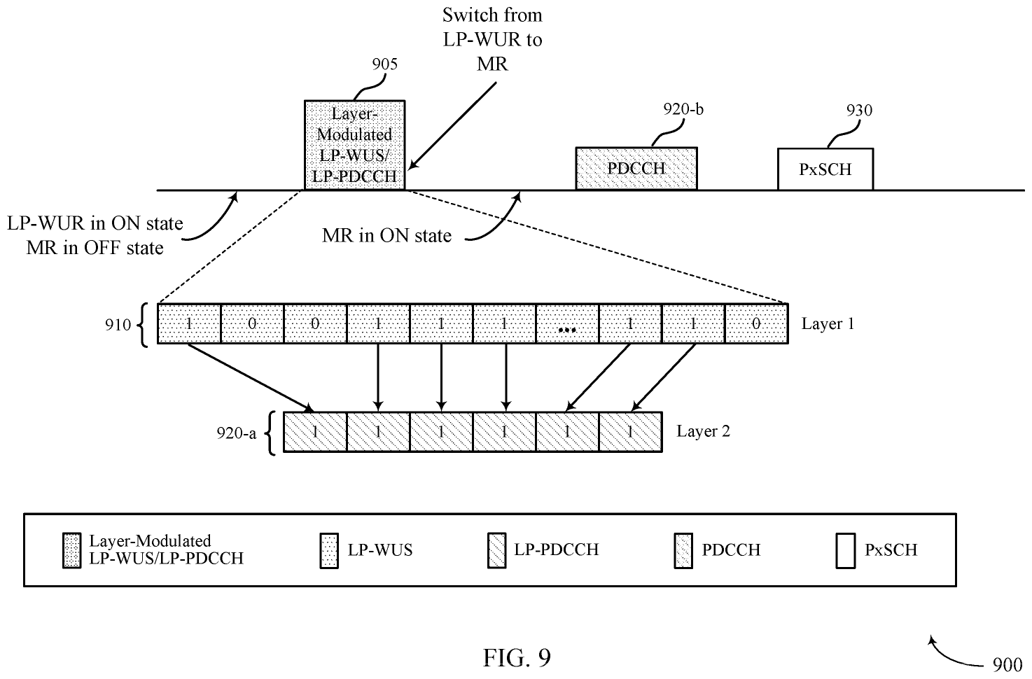

FIG. 9 shows an aspect of a signal design 900 that supports techniques for transmission of main radio control information using an LP-WUR in accordance with one or more aspects of the present disclosure. In some aspects, signal design 900 may be implemented by aspects of the wireless communications system 100, as described with reference to FIGS. 1, or signal designs 300, 500, and 700, as described with reference to FIGS. 3, 4, 5, 6, 7, and 8. For example, a UE 115-d, a network entity 105-d, or a combination thereof, may be configured to operate in accordance with the signal design 900. The UE 115-d and the network entity 105-d may be examples of the UE 115 and network entity 105 described with reference to FIG. 1, the UE 115-a and network entity 105-a described with reference to FIGS. 3 and 4, the UE 115-b and network entity 105-b described with reference to FIGS. 5 and 6, or the UE 115-c and network entity 105-c described with reference to FIGS. 7 and 8. In some aspects, the UE 115-d may be configured with a LP-WUR, and the signal design 900 may support the use of the LP-WUR at the UE 115-d as the hardware for LP-WUS and LP-PDCCH monitoring. The LP-WUR may implement a lower-complexity hardware design relative to that of a main radio operating at the UE 115-d, resulting in reduced power consumption at the UE 115-d.

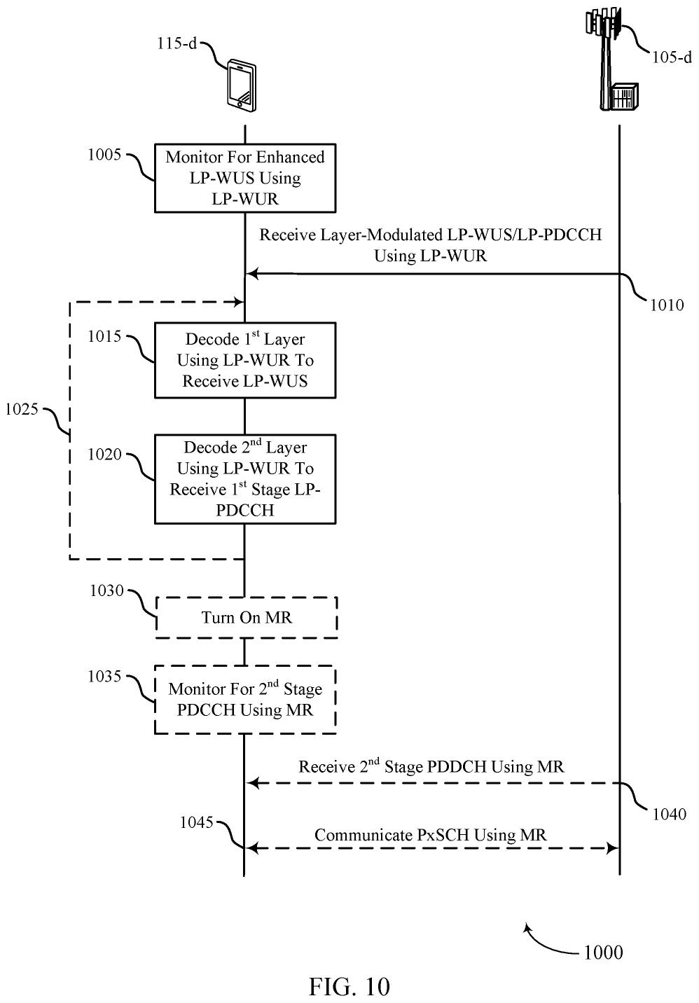

FIG. 10 shows an aspect of a signal flow 1000 associated with the signal design 900 of FIG. 9, which supports techniques for transmission of main radio control information using an LP-WUR in accordance with one or more aspects of the present disclosure. In some aspects, the signal flow 1000 may implement or be implemented by aspects of the wireless communications systems 100 and signal flows 400, 600, and 800 as described with reference to FIGS. 1, 4, 6, and 8, respectively. The signal flow 1000 may illustrate the flow of signals between the UE 115-d and the network entity 105-d. In the following description of the signal flow 1000, the communications between the UE 115-d and the network entity 105-d may be transmitted in a different order than the order shown, or the operations performed by the UE 115-d and the network entity 105-d may be performed in different orders or at different times. Some operations may also be omitted from the signal flow 1000, and other operations may be added to the signal flow 1000. In some aspects, the operations illustrated in signal flow 1000 may be performed by hardware (e.g., including circuitry, processing blocks, logic components, and other components), code (e.g., software or firmware) executed by a processor, or any combination thereof. Alternatively, some steps may be performed in a different order than described or might not be performed at all. In some cases, steps may include additional features not mentioned below, or further steps may be added.

Referring to FIGS. 9 and 10, in idle, inactive, or sleep modes, the UE 115-d may turn off its main radio and switch to its LP-WUR to operate in a low-power mode in order to save power. The UE 115-d may use the LP-WUR to monitor for one or more LP-WUSs and one or more LP-PDCCH messages.

At step 1005, the UE 115-d may monitor for an enhanced LP-WUS using the LP-WUR. The enhanced LP-WUS may be a layer-modulated LP-WUS/LP-PDCCH 905. The network entity 105-d may pre-configure one or more occasions for receiving enhanced LP-WUSs, and the UE 115-d may monitor one or more of the enhanced LP-WUS occasions for the layer-modulated LP-WUS/LP-PDCCH 905. The enhanced LP-WUS occasions may be preconfigured in a manner similar to that described for the LP-WUS or LP-PDCCH occasions described with reference to FIGS. 3 and 4.

At step 1010, the network entity 105-d may transmit and the UE 115-d may receive, using the LP-WUR, the layer-modulated LP-WUS/LP-PDCCH 905 during one of the enhanced LP-WUS occasions. The layer-modulated LP-WUS/LP-PDCCH 905 may be an LP-WUS enhanced to carry LP-PDCCH information. For instance, the LP-WUS may be an on-off keying (OOK) signal, in which the amplitude of a carrier wave is varied to signal binary information. For instance, when the amplitude of the waveform is greater than a threshold amount, the binary state may be 1, and when the amplitude is equal to or below a threshold amount the binary state may be 0. In this way, by varying the amplitude of the waveform, a sequence of bits may be encoded to generate the layer-modulated LP-WUS/LP-PDCCH 905.

At step 1015, the UE 115-d may decode a first layer 910 of the layer-modulated LP-WUS/LP-PDCCH 905. The first layer 910 of the layer-modulated LP-WUS/LP-PDCCH 905 may serve as the LP-WUS. For instance the first layer may signal the group or sub-group ID of those UEs, including the UE 115-d, selected to wake up to potentially communicate an upcoming PxSCH message 1030. In some cases, a Manchester coding scheme may be used for the first layer 910 of the layer-modulated LP-WUS/LP-PDCCH 905, in which case a quantity of high-energy intervals is fixed.

At step 1020, the UE 115-d may decode a second layer 920-a of the layer-modulated LP-WUS/LP-PDCCH 905. The second layer 920-a of the layer-modulated LP-WUS/LP-PDCCH 905 may carry the LP-PDCCH information. For instance the LP-PDCCH message may be modulated on the ‘1’ bit of the layer-modulated LP-WUS/LP-PDCCH 905. The second layer 920-a may carry UE-specific LP-PDCCH information. Accordingly, the second layer 920-a may enable further down selection (from the group or sub-group indicated by the first layer 910) to a particular UE, such as the UE 115-d.

Accordingly, the UE 115-d may decode the second layer 920-a to determine whether the LP-PDCCH message encoded therein is directed to the UE 115-d. In some cases, the second layer 920-a carrying the LP-PDCCH message may further include a grant scheduling resources for the upcoming PxSCH message 1030. In other cases, the second layer 920-a might not include a grant scheduling resources for the upcoming PxSCH message 1030 and, instead, may include a grant scheduling resources for a second PDCCH message, such as second-stage PDCCH message 1020-b. The LP-PDCCH message embedded in the second layer 920-a may be similar to the LP-PDCCH message 320-a of FIG. 3.

At step 1025, if the UE 115-d determines that the LP-PDCCH message encoded in the second layer 920-a is not targeted to the UE 115-d, the UE 115-d may continue to monitor for further enhanced LP-WUSs (or non-enhanced LP-WUSs or LP-PDCCHs) using the LP-WUR . . . .

At step 1030, if the UE 115-d determines that the LP-PDCCH message encoded in the second layer 920-a is targeted to the UE 115-d, the UE 115-d may then turn on its main radio to begin monitoring for the second-stage PDCCH message 1020-b (if scheduled by the LP-PDCCH message encoded in the second layer 920-a) or directly for the upcoming PxSCH message 1030 (if scheduled by the LP-PDCCH message encoded in the second layer 920-a).

At step 1035, if the LP-PDCCH message encoded in the second layer 920-a was targeted to the UE 115-d and if the LP-PDCCH message included a scheduling grant for the second-stage PDCCH message 1020-b, then the UE 115-d may use its main radio to monitor the scheduled resources for the second-stage PDCCH message 1020-b.

At step 1040, if the LP-PDCCH message encoded in the second layer 920-a included a scheduling grant for the second-stage PDCCH message 1020-b, the network entity 105-d may transmit and the UE 115-d may receive, using the main radio, the second-stage PDCCH message 1020-b. The UE 115-d may decode the second-stage PDCCH message 1020-b to receive the scheduling grant for the upcoming PxSCH message 1030.

At step 445, the UE 115-a may use the main radio to communicate the PxSCH message 1030 (such as transmit a PUSCH message to the network entity 105-d or receive a PDSCH message from the network entity 105-d) using the resources scheduled by either the LP-PDCCH message encoded in the second layer 920-a of the layer-modulated LP-WUS/LP-PDCCH 905 or the second-stage PDCCH message 920-b.

In some implementations, a UE (such as the UE 115, 115-a, 115-b, 115-c, or 115-d of FIGS. 1, 3, 5, 7, and 9) may be configured to implement one or more of the signal designs or signal flows described with respect to FIGS. 1 and 3-10. The UE may also be configured to switch between one or more of the signal designs or signal flows described with respect to FIGS. 1 and 3-10.

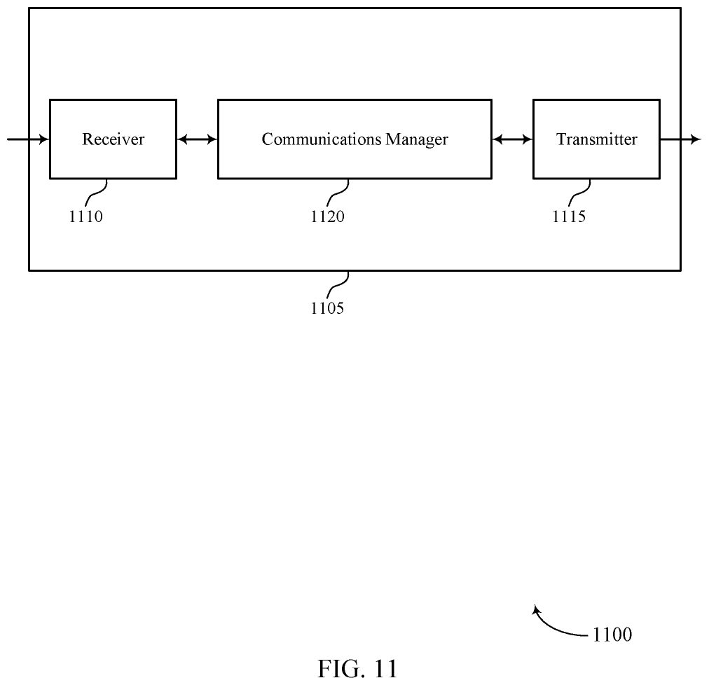

FIG. 11 shows a block diagram 1100 of a device 1105 that supports techniques for transmission of main radio control information using an LP-WUR in accordance with one or more aspects of the present disclosure. The device 1105 may be an example of aspects of a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for transmission of main radio control information using an LP-WUR). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for transmission of main radio control information using an LP-WUR). In some aspects, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations or components thereof may be examples of means for performing various aspects of techniques for transmission of main radio control information using an LP-WUR as described herein. For example, the communications manager 1120, the receiver 1110, the transmitter 1115, or various combinations or components thereof may be capable of performing one or more of the functions described herein.

In some aspects, the communications manager 1120, the receiver 1110, the transmitter 1115, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with aspects as disclosed herein. For example, the communications manager 1120 is capable of, configured to, or operable to support a means for receiving, via a first radio, a PDCCH message that is indicative that the first network entity is to switch from use of the first radio to a second radio, where the first radio is limited with respect to the second radio. The communications manager 1120 is capable of, configured to, or operable to support a means for switching the second radio to an on state based on receipt, via the first radio, of the PDCCH message. The communications manager 1120 is capable of, configured to, or operable to support a means for participating, after the switch, in communication of a data message with a second network entity via the second radio.

Additionally, or alternatively, the communications manager 1120 may support wireless communications in accordance with aspects as disclosed herein. For example, the communications manager 1120 is capable of, configured to, or operable to support a means for receiving, via a first radio, a LP-WUS, where the first radio is limited with respect to a second radio, and where the second radio is in an off state. The communications manager 1120 is capable of, configured to, or operable to support a means for monitoring, based on detection of the LP-WUS and via the first radio, for a PDCCH message that is indicative that the network entity is to switch from use of the first radio to the second radio. The communications manager 1120 is capable of, configured to, or operable to support a means for maintaining, based on an elapse of a predetermined time period without detection of the PDCCH message, the second radio in the off state.

By including or configuring the communications manager 1120 in accordance with aspects as described herein, the device 1105 (e.g., at least one processor controlling or otherwise coupled with the receiver 1110, the transmitter 1115, the communications manager 1120, or a combination thereof) may support techniques for reduced processing and reduced power consumption.

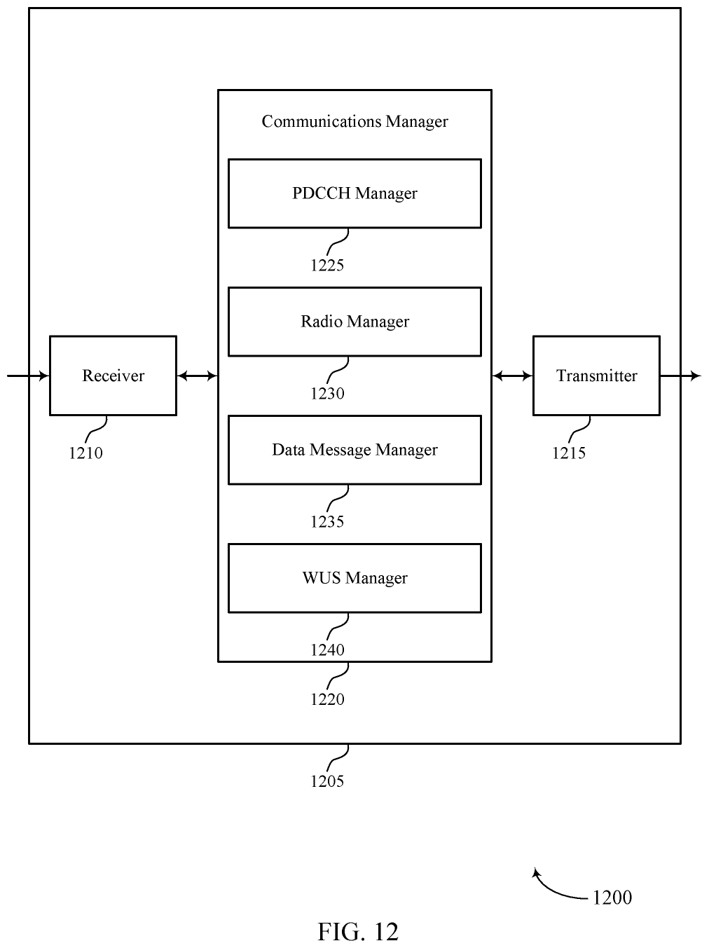

FIG. 12 shows a block diagram 1200 of a device 1205 that supports techniques for transmission of main radio control information using an LP-WUR in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205, or one of more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for transmission of main radio control information using an LP-WUR). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for transmission of main radio control information using an LP-WUR). In some aspects, the transmitter 1215 may be co-located with a receiver 1210 in a transceiver module. The transmitter 1215 may utilize a single antenna or a set of multiple antennas.

The device 1205, or various components thereof, may be an example of means for performing various aspects of techniques for transmission of main radio control information using an LP-WUR as described herein. For example, the communications manager 1220 may include a PDCCH manager 1225, a radio manager 1230, a data message manager 1235, a WUS manager 1240, or any combination thereof. The communications manager 1220 may be an example of aspects of a communications manager 1120 as described herein. In some aspects, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with aspects as disclosed herein. The PDCCH manager 1225 is capable of, configured to, or operable to support a means for receiving, via a first radio, a PDCCH message that is indicative that the first network entity is to switch from use of the first radio to a second radio, where the first radio is limited with respect to the second radio. The radio manager 1230 is capable of, configured to, or operable to support a means for switching the second radio to an on state based on receipt, via the first radio, of the PDCCH message. The data message manager 1235 is capable of, configured to, or operable to support a means for participating, after the switch, in communication of a data message with a second network entity via the second radio.

Additionally, or alternatively, the communications manager 1220 may support wireless communications in accordance with aspects as disclosed herein. The WUS manager 1240 is capable of, configured to, or operable to support a means for receiving, via a first radio, a LP-WUS, where the first radio is limited with respect to a second radio, and where the second radio is in an off state. The PDCCH manager 1225 is capable of, configured to, or operable to support a means for monitoring, based on detection of the LP-WUS and via the first radio, for a PDCCH message that is indicative that the network entity is to switch from use of the first radio to the second radio. The radio manager 1230 is capable of, configured to, or operable to support a means for maintaining, based on an elapse of a predetermined time period without detection of the PDCCH message, the second radio in the off state.

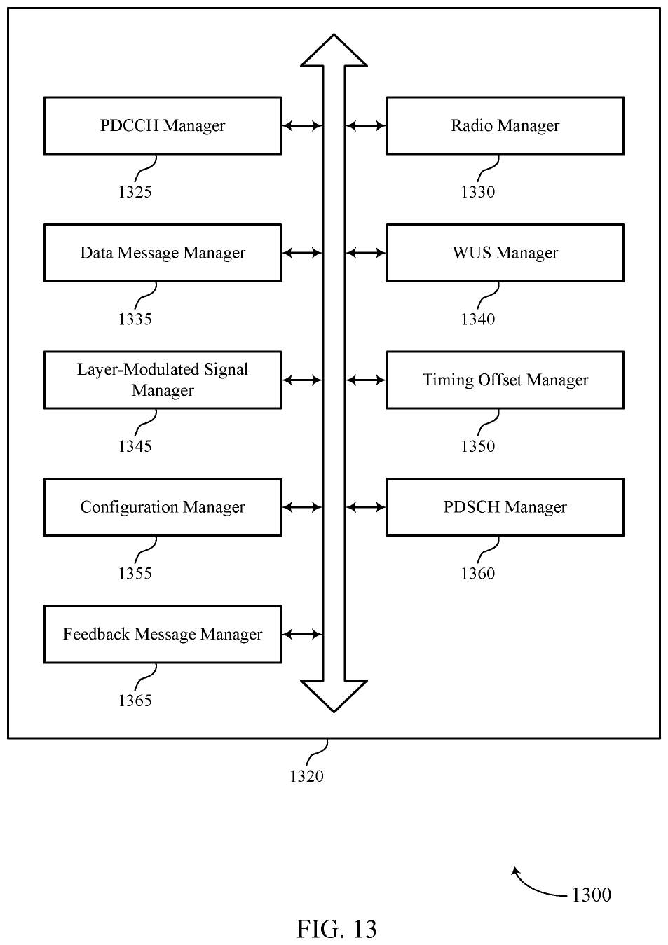

FIG. 13 shows a block diagram 1300 of a communications manager 1320 that supports techniques for transmission of main radio control information using an LP-WUR in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for transmission of main radio control information using an LP-WUR as described herein. For example, the communications manager 1320 may include a PDCCH manager 1325, a radio manager 1330, a data message manager 1335, a WUS manager 1340, a layer-modulated signal manager 1345, a timing offset manager 1350, a configuration manager 1355, an PDSCH manager 1360, a feedback message manager 1365, or any combination thereof. Each of these components, or components or subcomponents thereof (e.g., one or more processors, one or more memories), may communicate, directly or indirectly, with one another (e.g., via one or more buses).

The communications manager 1320 may support wireless communications in accordance with aspects as disclosed herein. The PDCCH manager 1325 is capable of, configured to, or operable to support a means for receiving, via a first radio, a PDCCH message that is indicative that the first network entity is to switch from use of the first radio to a second radio, where the first radio is limited with respect to the second radio. The radio manager 1330 is capable of, configured to, or operable to support a means for switching the second radio to an on state based on receipt, via the first radio, of the PDCCH message. The data message manager 1335 is capable of, configured to, or operable to support a means for participating, after the switch, in communication of a data message with a second network entity via the second radio.

In some aspects, the WUS manager 1340 is capable of, configured to, or operable to support a means for receiving, via the first radio and during a first occasion, a LP-WUS, where the PDCCH message is received based on reception of the LP-WUS and during a second occasion that is subsequent to the first occasion.

In some aspects, the LP-WUS is a sub-group common wakeup signal received at a set of multiple network entities. In some aspects, the set of multiple network entities includes the first network entity. In some aspects, the PDCCH message is specific to the first network entity.

In some aspects, the timing offset manager 1350 is capable of, configured to, or operable to support a means for receiving, via radio resource control signaling, an indication of a timing offset between a first timing resource allocated to the LP-WUS and a second timing resource allocated to the PDCCH message, where the second occasion is based on the first occasion and the timing offset.

In some aspects, the LP-WUS includes an indication of a timing offset between a first timing resource allocated to the LP-WUS and a second timing resource allocated to the PDCCH message. In some aspects, the second occasion is based on the first occasion and the timing offset.

In some aspects, the configuration manager 1355 is capable of, configured to, or operable to support a means for receiving, via radio resource control signaling, configuration information that indicates one or more first occasions for reception of LP-WUSs or one or more second occasions for reception of PDCCH messages, where the one or more first occasions includes the first occasion, and where the one or more second occasions includes the second occasion.

In some aspects, the LP-WUS is a sub-group common wakeup signal received at a set of multiple network entities, and the PDCCH manager 1325 is capable of, configured to, or operable to support a means for monitoring, via the second radio and based on detection of the LP-WUS, for a second PDCCH message including a groupcast, a multicast, or a broadcast message, where the second PDCCH message includes a downlink scheduling grant that indicates a set of resources associated with a physical downlink shared channel message. In some aspects, the LP-WUS is a sub-group common wakeup signal received at a set of multiple network entities, and the PDSCH manager 1360 is capable of, configured to, or operable to support a means for receiving, via the set of resources, the physical downlink shared channel message, where the physical downlink shared channel message includes a groupcast, a multicast, or a broadcast message.

In some aspects, the PDCCH message is a first-stage PDCCH message, and the PDCCH manager 1325 is capable of, configured to, or operable to support a means for receiving, via the second radio, a second-stage PDCCH message, where the second-stage PDCCH message includes a scheduling grant that indicates a first set of resources associated with the data message, and where the data message is communicated via the first set of resources.

In some aspects, the PDCCH message includes an indication of a second set of resources associated with the second-stage PDCCH message. In some aspects, the second-stage PDCCH message is received via the second set of resources.

In some aspects, the PDCCH message includes a first scheduling grant that indicates a first set of resources associated with the data message. In some aspects, the data message is communicated via the first set of resources and the second radio.

In some aspects, the PDCCH message includes a second scheduling grant that indicates a second set of resources for transmission of a feedback message associated with reception of the PDCCH message, and the feedback message manager 1365 is capable of, configured to, or operable to support a means for transmitting, to the second network entity, via the second set of resources and the second radio, and subsequent to reception of the PDCCH message, the feedback message.

In some aspects, when the first scheduling grant is an uplink grant, the first set of resources indicated by the first scheduling grant and the second set of resources indicated by the second scheduling grant include a same set of resources. In some aspects, participating in communication of the data message includes transmitting, to the second network entity and via the same set of resources, a physical uplink shared channel message including the data message and the feedback message.

In some aspects, the layer-modulated signal manager 1345 is capable of, configured to, or operable to support a means for decoding, with the first radio and based on detection of a layer-modulated signal, a first layer of the layer-modulated signal to detect a LP-WUS. In some aspects, the layer-modulated signal manager 1345 is capable of, configured to, or operable to support a means for decoding, with the first radio and based on an indication that the first network entity is associated with a sub-group associated with the LP-WUS, a second layer of the layer-modulated signal to detect the PDCCH message, where switching the second radio to the on state is further based on an indication that the PDCCH message is directed to the first network entity.

In some aspects, the first radio is a LP-WUR of the first network entity. In some aspects, the second radio is a main radio of the first network entity.

In some aspects, the PDCCH message is a low-power PDCCH message.

In some aspects, the first network entity is a UE.

Additionally, or alternatively, the communications manager 1320 may support wireless communications in accordance with aspects as disclosed herein. The WUS manager 1340 is capable of, configured to, or operable to support a means for receiving, via a first radio, a LP-WUS, where the first radio is limited with respect to a second radio, and where the second radio is in an off state. In some aspects, the PDCCH manager 1325 is capable of, configured to, or operable to support a means for monitoring, based on detection of the LP-WUS and via the first radio, for a PDCCH message that is indicative that the network entity is to switch from use of the first radio to the second radio. In some aspects, the radio manager 1330 is capable of, configured to, or operable to support a means for maintaining, based on an elapse of a predetermined time period without detection of the PDCCH message, the second radio in the off state.

In some aspects, the LP-WUS is a sub-group common wakeup signal received at a set of multiple network entities. In some aspects, the set of multiple network entities include the network entity. In some aspects, the PDCCH message is specific to the network entity.

In some aspects, the LP-WUS is received during a first occasion. In some aspects, the PDCCH message is received during a second occasion that is subsequent to the first occasion.

In some aspects, the timing offset manager 1350 is capable of, configured to, or operable to support a means for receiving, via radio resource control signaling, an indication of a timing offset between a first timing resource allocated to the LP-WUS and a second timing resource allocated to the PDCCH message, where the second occasion is based on the first occasion and the timing offset.

In some aspects, the LP-WUS includes an indication of a timing offset between a first timing resource allocated to the LP-WUS and a second timing resource allocated to the PDCCH message. In some aspects, the second occasion is based on the first occasion and the timing offset.

In some aspects, the first radio is a LP-WUR of the network entity. In some aspects, the second radio is a main radio of the network entity.

In some aspects, the network entity is a UE.

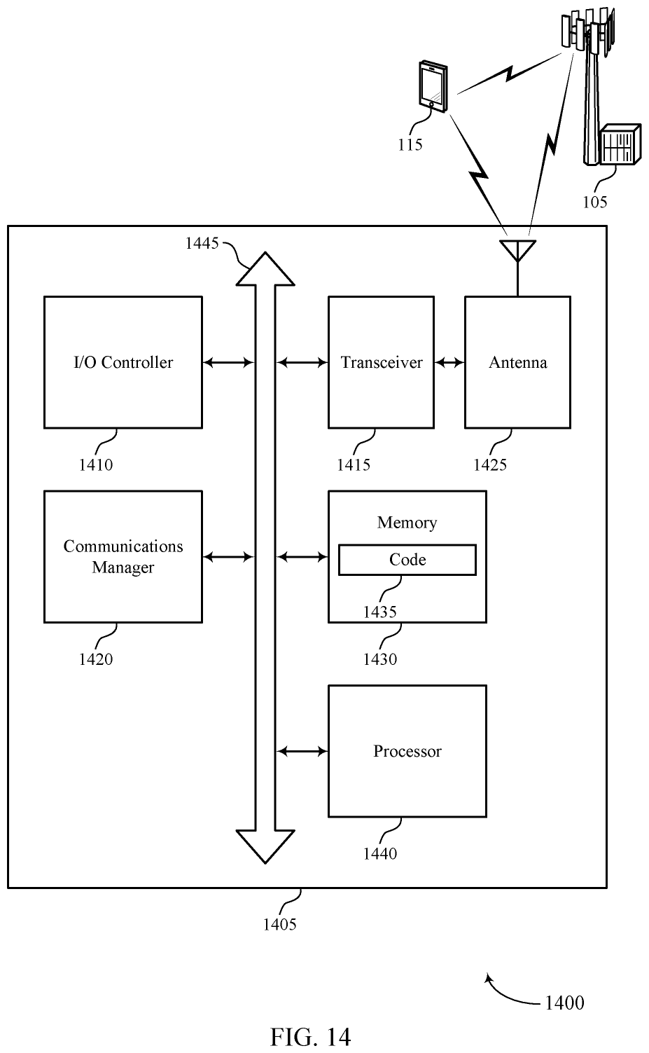

FIG. 14 shows a diagram of a system 1400 including a device 1405 that supports techniques for transmission of main radio control information using an LP-WUR in accordance with one or more aspects of the present disclosure. The device 1405 may be an example of or include components of a device 1105, a device 1205, or a UE 115 as described herein. The device 1405 may communicate (e.g., wirelessly) with one or more other devices (e.g., network entities 105, UEs 115, or a combination thereof). The device 1405 may include components for bi-directional voice and data communications including components for transmitting and receiving communications, such as a communications manager 1420, an input/output (I/O) controller, such as an I/O controller 1410, a transceiver 1415, one or more antennas 1425, at least one memory 1430, code 1435, and at least one processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another operating system. Additionally, or alternatively, the I/O controller 1410 may represent or interact with a modem, a keyboard, a mouse, a touchscreen, or a similar device. In some cases, the I/O controller 1410 may be implemented as part of one or more processors, such as the at least one processor 1440. In some cases, a user may interact with the device 1405 via the I/O controller 1410 or via hardware components controlled by the I/O controller 1410.

In some cases, the device 1405 may include a single antenna. However, in some other cases, the device 1405 may have more than one antenna, which may be capable of concurrently transmitting or receiving multiple wireless transmissions. The transceiver 1415 may communicate bi-directionally via the one or more antennas 1425 using wired or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The at least one memory 1430 may include random access memory (RAM) and read-only memory (ROM). The at least one memory 1430 may store computer-readable, computer-executable, or processor-executable code, such as the code 1435. The code 1435 may include instructions that, when executed by the at least one processor 1440, cause the device 1405 to perform various functions described herein. The code 1435 may be stored in a non-transitory computer-readable medium such as system memory or another type of memory. In some cases, the code 1435 may not be directly executable by the at least one processor 1440 but may cause a computer (e.g., when compiled and executed) to perform functions described herein. In some cases, the at least one memory 1430 may include, among other things, a basic I/O system (BIOS) which may control basic hardware or software operation such as the interaction with peripheral components or devices.

The at least one processor 1440 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1440 may be configured to operate a memory array using a memory controller. In some other cases, a memory controller may be integrated into the at least one processor 1440. The at least one processor 1440 may be configured to execute computer-readable instructions stored in a memory (e.g., the at least one memory 1430) to cause the device 1405 to perform various functions (e.g., functions or tasks supporting techniques for transmission of main radio control information using an LP-WUR). For example, the device 1405 or a component of the device 1405 may include at least one processor 1440 and at least one memory 1430 coupled with or to the at least one processor 1440, the at least one processor 1440 and the at least one memory 1430 configured to perform various functions described herein.

In some aspects, the at least one processor 1440 may include multiple processors and the at least one memory 1430 may include multiple memories. One or more of the multiple processors may be coupled with one or more of the multiple memories, which may, individually or collectively, be configured to perform various functions described herein. In some aspects, the at least one processor 1440 may be a component of a processing system, which may refer to a system (such as a series) of machines, circuitry (including, for example, one or both of processor circuitry (which may include the at least one processor 1440) and memory circuitry (which may include the at least one memory 1430)), or components, that receives or obtains inputs and processes the inputs to produce, generate, or obtain a set of outputs. The processing system may be configured to perform one or more of the functions described herein. For example, the at least one processor 1440 or a processing system including the at least one processor 1440 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code 1435 (e.g., processor-executable code) stored in the at least one memory 1430 or otherwise, to perform one or more of the functions described herein.

The communications manager 1420 may support wireless communications in accordance with aspects as disclosed herein. For example, the communications manager 1420 is capable of, configured to, or operable to support a means for receiving, via a first radio, a PDCCH message that is indicative that the first network entity is to switch from use of the first radio to a second radio, where the first radio is limited with respect to the second radio. The communications manager 1420 is capable of, configured to, or operable to support a means for switching the second radio to an on state based on receipt, via the first radio, of the PDCCH message. The communications manager 1420 is capable of, configured to, or operable to support a means for participating, after the switch, in communication of a data message with a second network entity via the second radio.

Additionally, or alternatively, the communications manager 1420 may support wireless communications in accordance with aspects as disclosed herein. For example, the communications manager 1420 is capable of, configured to, or operable to support a means for receiving, via a first radio, a LP-WUS, where the first radio is limited with respect to a second radio, and where the second radio is in an off state. The communications manager 1420 is capable of, configured to, or operable to support a means for monitoring, based on detection of the LP-WUS and via the first radio, for a PDCCH message that is indicative that the network entity is to switch from use of the first radio to the second radio. The communications manager 1420 is capable of, configured to, or operable to support a means for maintaining, based on an elapse of a predetermined time period without detection of the PDCCH message, the second radio in the off state.

By including or configuring the communications manager 1420 in accordance with aspects as described herein, the device 1405 may support techniques for improved communication reliability, reduced latency, and reduced power consumption.

In some aspects, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some aspects, one or more functions described with reference to the communications manager 1420 may be supported by or performed by the at least one processor 1440, the at least one memory 1430, the code 1435, or any combination thereof. For example, the code 1435 may include instructions executable by the at least one processor 1440 to cause the device 1405 to perform various aspects of techniques for transmission of main radio control information using an LP-WUR as described herein, or the at least one processor 1440 and the at least one memory 1430 may be otherwise configured to, individually or collectively, perform or support such operations.

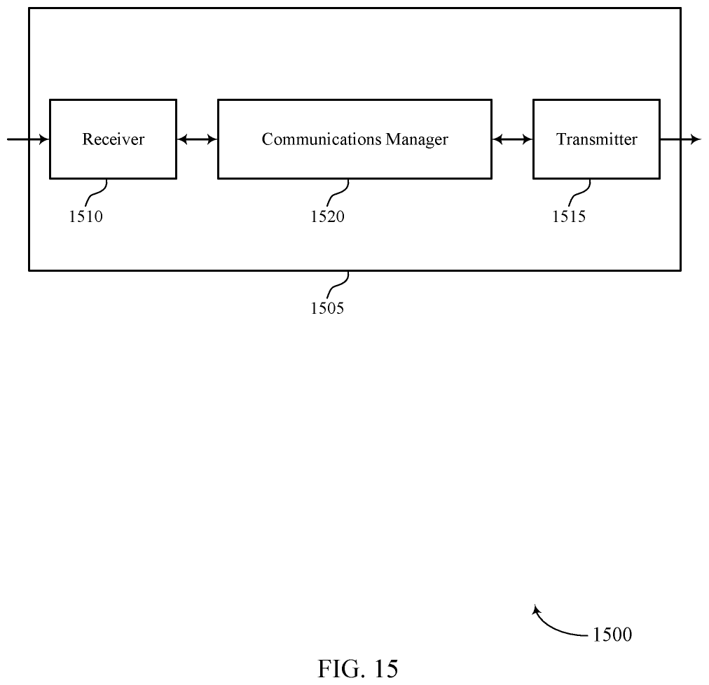

FIG. 15 shows a block diagram 1500 of a device 1505 that supports techniques for transmission of main radio control information using an LP-WUR in accordance with one or more aspects of the present disclosure. The device 1505 may be an example of aspects of a network entity 105 as described herein. The device 1505 may include a receiver 1510, a transmitter 1515, and a communications manager 1520. The device 1505, or one or more components of the device 1505 (e.g., the receiver 1510, the transmitter 1515, the communications manager 1520), may include at least one processor, which may be coupled with at least one memory, to, individually or collectively, support or enable the described techniques. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some aspects, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some aspects, the transmitter 1515 and the receiver 1510 may be co-located in a transceiver, which may include or be coupled with a modem.

The communications manager 1520, the receiver 1510, the transmitter 1515, or various combinations or components thereof may be examples of means for performing various aspects of techniques for transmission of main radio control information using an LP-WUR as described herein. For example, the communications manager 1520, the receiver 1510, the transmitter 1515, or various combinations or components thereof may be capable of performing one or more of the functions described herein.

In some aspects, the communications manager 1520, the receiver 1510, the transmitter 1515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1520, the receiver 1510, the transmitter 1515, or various combinations or components thereof may be implemented in code (e.g., as communications management software or firmware) executed by at least one processor (e.g., referred to as a processor-executable code). If implemented in code executed by at least one processor, the functions of the communications manager 1520, the receiver 1510, the transmitter 1515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 1520 may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications in accordance with aspects as disclosed herein. For example, the communications manager 1520 is capable of, configured to, or operable to support a means for transmitting, to a target second network entity of a set of multiple second network entities, a unicast PDCCH message that is indicative that the target second network entity is to switch from use of a first radio to a second radio, where the first radio is limited with respect to the second radio. The communications manager 1520 is capable of, configured to, or operable to support a means for scheduling a first set of resources for communication of a data message with the target second network entity.

By including or configuring the communications manager 1520 in accordance with aspects as described herein, the device 1505 (e.g., at least one processor controlling or otherwise coupled with the receiver 1510, the transmitter 1515, the communications manager 1520, or a combination thereof) may support techniques for reduced processing and reduced power consumption.

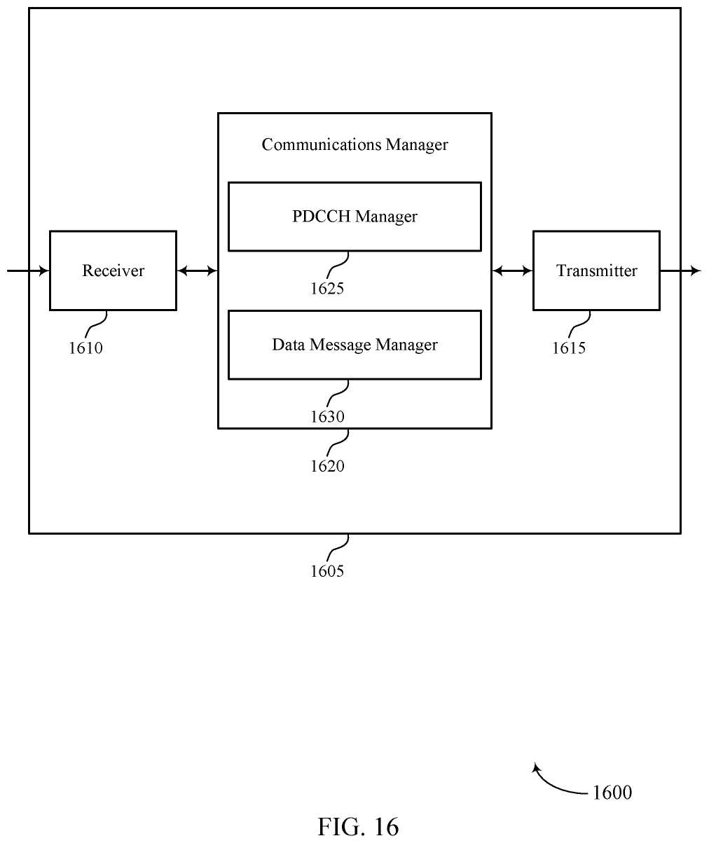

FIG. 16 shows a block diagram 1600 of a device 1605 that supports techniques for transmission of main radio control information using an LP-WUR in accordance with one or more aspects of the present disclosure. The device 1605 may be an example of aspects of a device 1505 or a network entity 105 as described herein. The device 1605 may include a receiver 1610, a transmitter 1615, and a communications manager 1620. The device 1605, or one of more components of the device 1605 (e.g., the receiver 1610, the transmitter 1615, the communications manager 1620), may include at least one processor, which may be coupled with at least one memory, to support the described techniques. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some aspects, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some aspects, the transmitter 1615 and the receiver 1610 may be co-located in a transceiver, which may include or be coupled with a modem.

The device 1605, or various components thereof, may be an example of means for performing various aspects of techniques for transmission of main radio control information using an LP-WUR as described herein. For example, the communications manager 1620 may include a PDCCH manager 1625 a data message manager 1630, or any combination thereof. The communications manager 1620 may be an example of aspects of a communications manager 1520 as described herein. In some aspects, the communications manager 1620, or various components thereof, may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with aspects as disclosed herein. The PDCCH manager 1625 is capable of, configured to, or operable to support a means for transmitting, to a target second network entity of a set of multiple second network entities, a unicast PDCCH message that is indicative that the target second network entity is to switch from use of a first radio to a second radio, where the first radio is limited with respect to the second radio. The data message manager 1630 is capable of, configured to, or operable to support a means for scheduling a first set of resources for communication of a data message with the target second network entity.

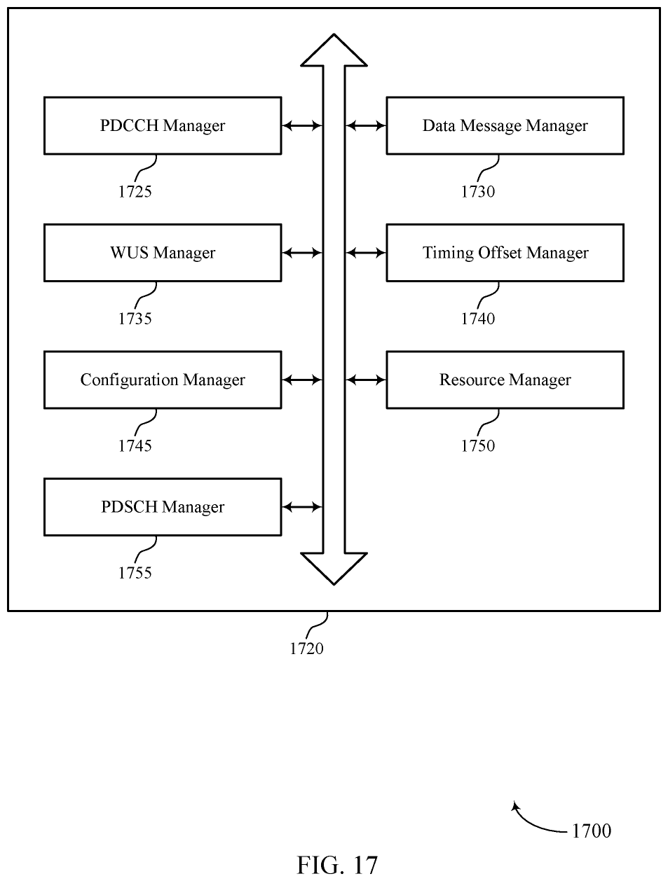

FIG. 17 shows a block diagram 1700 of a communications manager 1720 that supports techniques for transmission of main radio control information using an LP-WUR in accordance with one or more aspects of the present disclosure. The communications manager 1720 may be an example of aspects of a communications manager 1520, a communications manager 1620, or both, as described herein. The communications manager 1720, or various components thereof, may be an example of means for performing various aspects of techniques for transmission of main radio control information using an LP-WUR as described herein. For example, the communications manager 1720 may include a PDCCH manager 1725, a data message manager 1730, a WUS manager 1735, a timing offset manager 1740, a configuration manager 1745, a resource manager 1750, an PDSCH manager 1755, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1720 may support wireless communications in accordance with aspects as disclosed herein. The PDCCH manager 1725 is capable of, configured to, or operable to support a means for transmitting, to a target second network entity of a set of multiple second network entities, a unicast PDCCH message that is indicative that the target second network entity is to switch from use of a first radio to a second radio, where the first radio is limited with respect to the second radio. The data message manager 1730 is capable of, configured to, or operable to support a means for scheduling a first set of resources for communication of a data message with the target second network entity.

In some aspects, the unicast PDCCH message is a low-power PDCCH message.

In some aspects, the WUS manager 1735 is capable of, configured to, or operable to support a means for transmitting, to the set of multiple second network entities and during a first occasion, a LP-WUS, where the unicast PDCCH message is transmitted based on transmission of the LP-WUS and during a second occasion that is subsequent to the first occasion.

In some aspects, the timing offset manager 1740 is capable of, configured to, or operable to support a means for transmitting, via radio resource control signaling and to the target second network entity, an indication of a timing offset between a first timing resource allocated to the LP-WUS and second timing resource allocated to the unicast PDCCH message.

In some aspects, the LP-WUS includes an indication of a timing offset between a first timing resource allocated to the LP-WUS and a second timing resource allocated to the unicast PDCCH message.

In some aspects, the configuration manager 1745 is capable of, configured to, or operable to support a means for transmitting, via radio resource control signaling and to the target second network entity, configuration information that indicates one or more first occasions for reception of LP-WUSs, one or more second occasions for reception of PDCCH messages, or both, where the one or more first occasions includes the first occasion, and where the one or more second occasions includes the second occasion.

In some aspects, the unicast PDCCH message is a unicast first-stage PDCCH message, and the PDCCH manager 1725 is capable of, configured to, or operable to support a means for scheduling a second set of resources for transmission of a unicast second-stage PDCCH message, where the unicast first-stage PDCCH message includes an indication of the second set of resources. In some aspects, the unicast PDCCH message is a unicast first-stage PDCCH message, and the PDCCH manager 1725 is capable of, configured to, or operable to support a means for transmitting, to the target second network entity and via the second set of resources, the unicast second-stage PDCCH message, where the unicast second-stage PDCCH message includes a scheduling grant that indicates the first set of resources for communication of the data message.

In some aspects, the unicast PDCCH message includes a first scheduling grant that indicates the first set of resources for communication of the data message.

In some aspects, the unicast PDCCH message is a unicast first-stage PDCCH message. In some aspects, the unicast PDCCH message includes a second scheduling grant that indicates a second set of resources for a feedback message associated with reception of the unicast first-stage PDCCH message by the target second network entity.

In some aspects, the data message manager 1730 is capable of, configured to, or operable to support a means for participating, based on reception of the feedback message, in communication of the data message with the target second network entity via the first set of resources.

In some aspects, the resource manager 1750 is capable of, configured to, or operable to support a means for reallocating, based on an elapse of a predetermined time period without reception of the feedback message from the target second network entity, the first set of resources.

In some aspects, when the first scheduling grant is an uplink grant, the first set of resources indicated by the first scheduling grant and the second set of resources indicated by the second scheduling grant include a same set of resources. In some aspects, the PDSCH manager 1755 is capable of, configured to, or operable to support a means for receiving, from the target second network entity and via the same set of resources, a physical uplink shared channel message including the data message and the feedback message.

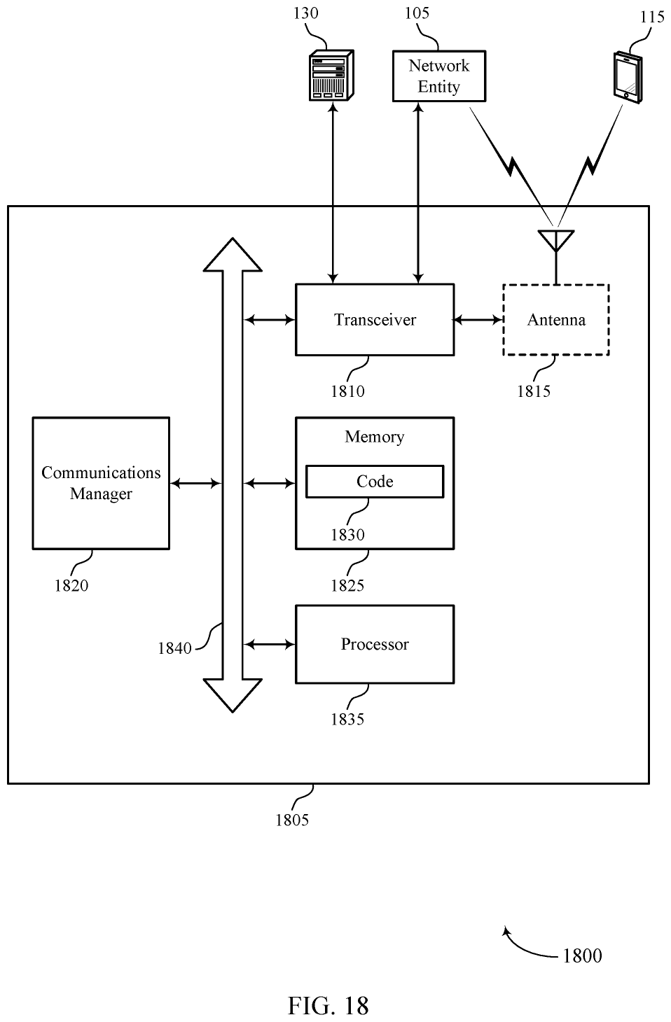

FIG. 18 shows a diagram of a system 1800 including a device 1805 that supports techniques for transmission of main radio control information using an LP-WUR in accordance with one or more aspects of the present disclosure. The device 1805 may be an example of or include components of a device 1505, a device 1605, or a network entity 105 as described herein. The device 1805 may communicate with other network devices or network equipment such as one or more of the network entities 105, UEs 115, or any combination thereof. The communications may include communications over one or more wired interfaces, over one or more wireless interfaces, or any combination thereof. The device 1805 may include components that support outputting and obtaining communications, such as a communications manager 1820, a transceiver 1810, one or more antennas 1815, at least one memory 1825, code 1830, and at least one processor 1835. These components may be in electronic communication or otherwise coupled (e.g., operatively, communicatively, functionally, electronically, electrically) via one or more buses (e.g., a bus 1840).

The transceiver 1810 may support bi-directional communications via wired links, wireless links, or both as described herein. In some aspects, the transceiver 1810 may include a wired transceiver and may communicate bi-directionally with another wired transceiver. Additionally, or alternatively, in some aspects, the transceiver 1810 may include a wireless transceiver and may communicate bi-directionally with another wireless transceiver. In some aspects, the device 1805 may include one or more antennas 1815, which may be capable of transmitting or receiving wireless transmissions (e.g., concurrently). The transceiver 1810 may also include a modem to modulate signals, to provide the modulated signals for transmission (e.g., by one or more antennas 1815, by a wired transmitter), to receive modulated signals (e.g., from one or more antennas 1815, from a wired receiver), and to demodulate signals. In some implementations, the transceiver 1810 may include one or more interfaces, such as one or more interfaces coupled with the one or more antennas 1815 that are configured to support various receiving or obtaining operations, or one or more interfaces coupled with the one or more antennas 1815 that are configured to support various transmitting or outputting operations, or a combination thereof. In some implementations, the transceiver 1810 may include or be configured for coupling with one or more processors or one or more memory components that are operable to perform or support operations based on received or obtained information or signals, or to generate information or other signals for transmission or other outputting, or any combination thereof. In some implementations, the transceiver 1810, or the transceiver 1810 and the one or more antennas 1815, or the transceiver 1810 and the one or more antennas 1815 and one or more processors or one or more memory components (e.g., the at least one processor 1835, the at least one memory 1825, or both), may be included in a chip or chip assembly that is installed in the device 1805. In some aspects, the transceiver 1810 may be operable to support communications via one or more communications links (e.g., communication link(s) 125, backhaul communication link(s) 120, a midhaul communication link 162, a fronthaul communication link 168).

The at least one memory 1825 may include RAM, ROM, or any combination thereof. The at least one memory 1825 may store computer-readable, computer-executable, or processor-executable code, such as the code 1830. The code 1830 may include instructions that, when executed by one or more of the at least one processor 1835, cause the device 1805 to perform various functions described herein. The code 1830 may be stored in a non-transitory computer-readable medium such as system memory or another type of memory. In some cases, the code 1830 may not be directly executable by a processor of the at least one processor 1835 but may cause a computer (e.g., when compiled and executed) to perform functions described herein. In some cases, the at least one memory 1825 may include, among other things, a BIOS which may control basic hardware or software operation such as the interaction with peripheral components or devices. In some aspects, the at least one processor 1835 may include multiple processors and the at least one memory 1825 may include multiple memories. One or more of the multiple processors may be coupled with one or more of the multiple memories which may, individually or collectively, be configured to perform various functions herein (for example, as part of a processing system).

The at least one processor 1835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1835 may be configured to operate a memory array using a memory controller. In some other cases, a memory controller may be integrated into one or more of the at least one processor 1835. The at least one processor 1835 may be configured to execute computer-readable instructions stored in a memory (e.g., one or more of the at least one memory 1825) to cause the device 1805 to perform various functions (e.g., functions or tasks supporting techniques for transmission of main radio control information using an LP-WUR). For example, the device 1805 or a component of the device 1805 may include at least one processor 1835 and at least one memory 1825 coupled with one or more of the at least one processor 1835, the at least one processor 1835 and the at least one memory 1825 configured to perform various functions described herein. The at least one processor 1835 may be an example of a cloud-computing platform (e.g., one or more physical nodes and supporting software such as operating systems, virtual machines, or container instances) that may host the functions (e.g., by executing code 1830) to perform the functions of the device 1805. The at least one processor 1835 may be any one or more suitable processors capable of executing scripts or instructions of one or more software programs stored in the device 1805 (such as within one or more of the at least one memory 1825).

In some aspects, the at least one processor 1835 may include multiple processors and the at least one memory 1825 may include multiple memories. One or more of the multiple processors may be coupled with one or more of the multiple memories, which may, individually or collectively, be configured to perform various functions herein. In some aspects, the at least one processor 1835 may be a component of a processing system, which may refer to a system (such as a series) of machines, circuitry (including, for example, one or both of processor circuitry (which may include the at least one processor 1835) and memory circuitry (which may include the at least one memory 1825)), or components, that receives or obtains inputs and processes the inputs to produce, generate, or obtain a set of outputs. The processing system may be configured to perform one or more of the functions described herein. For example, the at least one processor 1835 or a processing system including the at least one processor 1835 may be configured to, configurable to, or operable to cause the device 1805 to perform one or more of the functions described herein. Further, as described herein, being “configured to,” being “configurable to,” and being “operable to” may be used interchangeably and may be associated with a capability, when executing code stored in the at least one memory 1825 or otherwise, to perform one or more of the functions described herein.

In some aspects, a bus 1840 may support communications of (e.g., within) a protocol layer of a protocol stack. In some aspects, a bus 1840 may support communications associated with a logical channel of a protocol stack (e.g., between protocol layers of a protocol stack), which may include communications performed within a component of the device 1805, or between different components of the device 1805 that may be co-located or located in different locations (e.g., where the device 1805 may refer to a system in which one or more of the communications manager 1820, the transceiver 1810, the at least one memory 1825, the code 1830, and the at least one processor 1835 may be located in one of the different components or divided between different components).

In some aspects, the communications manager 1820 may manage aspects of communications with a core network 130 (e.g., via one or more wired or wireless backhaul links). For example, the communications manager 1820 may manage the transfer of data communications for client devices, such as one or more UEs 115. In some aspects, the communications manager 1820 may manage communications with one or more other network entities 105, and may include a controller or scheduler for controlling communications with UEs 115 (e.g., in cooperation with the one or more other network devices). In some aspects, the communications manager 1820 may support an X2 interface within an LTE/LTE-A wireless communications network technology to provide communication between network entities 105.

The communications manager 1820 may support wireless communications in accordance with aspects as disclosed herein. For example, the communications manager 1820 is capable of, configured to, or operable to support a means for transmitting, to a target second network entity of a set of multiple second network entities, a unicast PDCCH message that is indicative that the target second network entity is to switch from use of a first radio to a second radio, where the first radio is limited with respect to the second radio. The communications manager 1820 is capable of, configured to, or operable to support a means for scheduling a first set of resources for communication of a data message with the target second network entity.

By including or configuring the communications manager 1820 in accordance with aspects as described herein, the device 1805 may support techniques for improved communication reliability, reduced latency, and reduced power consumption.

In some aspects, the communications manager 1820 may be configured to perform various operations (e.g., receiving, obtaining, monitoring, outputting, transmitting) using or otherwise in cooperation with the transceiver 1810, the one or more antennas 1815 (e.g., where applicable), or any combination thereof. Although the communications manager 1820 is illustrated as a separate component, in some aspects, one or more functions described with reference to the communications manager 1820 may be supported by or performed by the transceiver 1810, one or more of the at least one processor 1835, one or more of the at least one memory 1825, the code 1830, or any combination thereof (for example, by a processing system including at least a portion of the at least one processor 1835, the at least one memory 1825, the code 1830, or any combination thereof). For example, the code 1830 may include instructions executable by one or more of the at least one processor 1835 to cause the device 1805 to perform various aspects of techniques for transmission of main radio control information using an LP-WUR as described herein, or the at least one processor 1835 and the at least one memory 1825 may be otherwise configured to, individually or collectively, perform or support such operations.

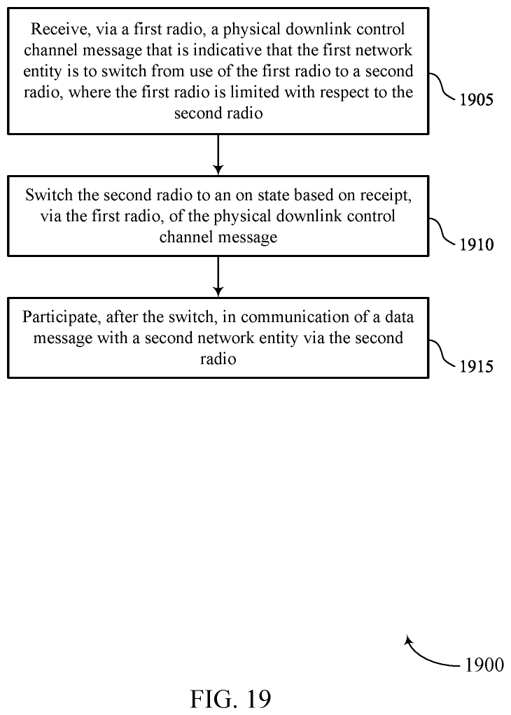

FIG. 19 shows a flowchart illustrating a method 1900 that supports techniques for transmission of main radio control information using an LP-WUR in accordance with one or more aspects of the present disclosure. The operations of the method 1900 may be implemented by a UE or its components as described herein. For example, the operations of the method 1900 may be performed by a UE 115 as described with reference to FIGS. 1 through 14. In some aspects, a UE may execute a set of instructions to control the functional elements of the UE to perform the described functions. Additionally, or alternatively, the UE may perform aspects of the described functions using special-purpose hardware.

At 1905, the method may include receiving, via a first radio, a PDCCH message that is indicative that the first network entity is to switch from use of the first radio to a second radio, where the first radio is limited with respect to the second radio. The operations of 1905 may be performed in accordance with aspects as disclosed herein. In some aspects, aspects of the operations of 1905 may be performed by a PDCCH manager 1325 as described with reference to FIG. 13.

At 1910, the method may include switching the second radio to an on state based on receipt, via the first radio, of the PDCCH message. The operations of 1910 may be performed in accordance with aspects as disclosed herein. In some aspects, aspects of the operations of 1910 may be performed by a radio manager 1330 as described with reference to FIG. 13.

At 1915, the method may include participating, after the switch, in communication of a data message with a second network entity via the second radio. The operations of 1915 may be performed in accordance with aspects as disclosed herein. In some aspects, aspects of the operations of 1915 may be performed by a data message manager 1335 as described with reference to FIG. 13.

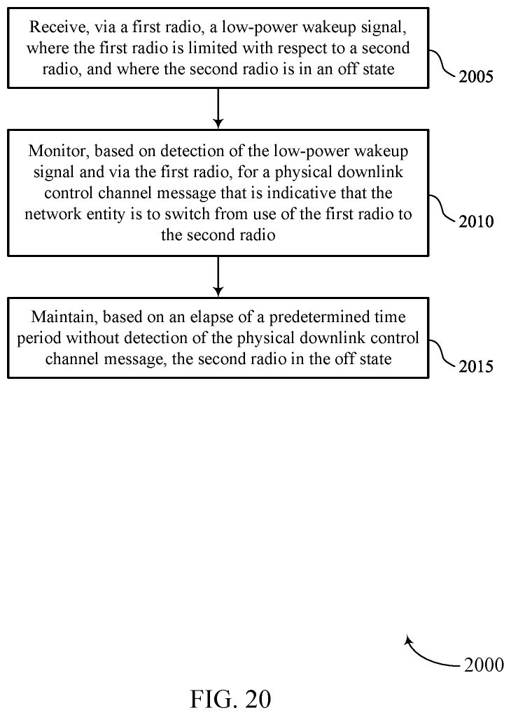

FIG. 20 shows a flowchart illustrating a method 2000 that supports techniques for transmission of main radio control information using an LP-WUR in accordance with one or more aspects of the present disclosure. The operations of the method 2000 may be implemented by a UE or its components as described herein. For example, the operations of the method 2000 may be performed by a UE 115 as described with reference to FIGS. 1 through 14. In some aspects, a UE may execute a set of instructions to control the functional elements of the UE to perform the described functions. Additionally, or alternatively, the UE may perform aspects of the described functions using special-purpose hardware.

At 2005, the method may include receiving, via a first radio, a LP-WUS, where the first radio is limited with respect to a second radio, and where the second radio is in an off state. The operations of 2005 may be performed in accordance with aspects as disclosed herein. In some aspects, aspects of the operations of 2005 may be performed by a WUS manager 1340 as described with reference to FIG. 13.

At 2010, the method may include monitoring, based on detection of the LP-WUS and via the first radio, for a PDCCH message that is indicative that the network entity is to switch from use of the first radio to the second radio. The operations of 2010 may be performed in accordance with aspects as disclosed herein. In some aspects, aspects of the operations of 2010 may be performed by a PDCCH manager 1325 as described with reference to FIG. 13.

At 2015, the method may include maintaining, based on an elapse of a predetermined time period without detection of the PDCCH message, the second radio in the off state. The operations of 2015 may be performed in accordance with aspects as disclosed herein. In some aspects, aspects of the operations of 2015 may be performed by a radio manager 1330 as described with reference to FIG. 13.

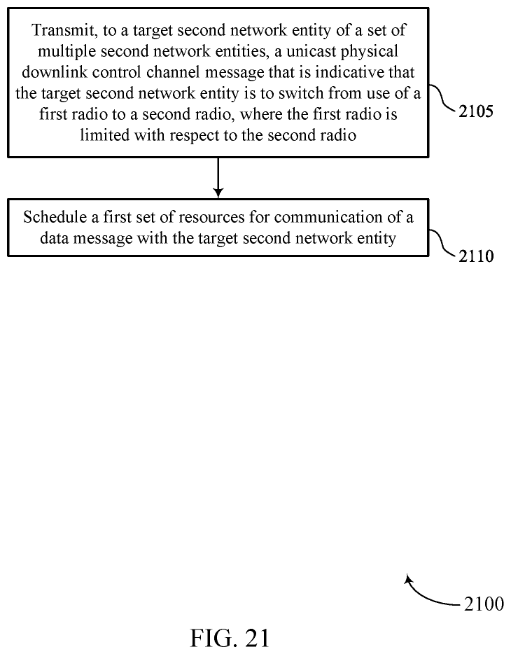

FIG. 21 shows a flowchart illustrating a method 2100 that supports techniques for transmission of main radio control information using an LP-WUR in accordance with one or more aspects of the present disclosure. The operations of the method 2100 may be implemented by a network entity or its components as described herein. For example, the operations of the method 2100 may be performed by a network entity as described with reference to FIGS. 1 through 10 and 15 through 18. In some aspects, a network entity may execute a set of instructions to control the functional elements of the network entity to perform the described functions. Additionally, or alternatively, the network entity may perform aspects of the described functions using special-purpose hardware.

At 2105, the method may include transmitting, to a target second network entity of a set of multiple second network entities, a unicast PDCCH message that is indicative that the target second network entity is to switch from use of a first radio to a second radio, where the first radio is limited with respect to the second radio. The operations of 2105 may be performed in accordance with aspects as disclosed herein. In some aspects, aspects of the operations of 2105 may be performed by a PDCCH manager 1725 as described with reference to FIG. 17.

At 2110, the method may include scheduling a first set of resources for communication of a data message with the target second network entity. The operations of 2110 may be performed in accordance with aspects as disclosed herein. In some aspects, aspects of the operations of 2110 may be performed by a data message manager 1730 as described with reference to FIG. 17.

The following provides an overview of aspects of the present disclosure:

Aspect 1: A method for wireless communications by a first network entity, comprising: receiving, via a first radio, a physical downlink control channel message that is indicative that the first network entity is to switch from use of the first radio to a second radio, wherein the first radio is limited with respect to the second radio; switching the second radio to an on state based on receipt, via the first radio, of the physical downlink control channel message; and participating, after the switch, in communication of a data message with a second network entity via the second radio.

Aspect 2: The method of aspect 1, further comprising: receiving, via the first radio and during a first occasion, a low-power wakeup signal, wherein the physical downlink control channel message is received based on reception of the low-power wakeup signal and during a second occasion that is subsequent to the first occasion.

Aspect 3: The method of aspect 2, wherein the low-power wakeup signal is a sub-group common wakeup signal received at a plurality of network entities, and wherein the method further comprises: monitoring, via the second radio and based on detection of the low-power wakeup signal, for a second physical downlink control channel message comprising a groupcast, a multicast, or a broadcast message, wherein the second physical downlink control channel message includes a downlink scheduling grant that indicates a set of resources associated with a physical downlink shared channel message; and receiving, via the set of resources, the physical downlink shared channel message, wherein the physical downlink shared channel message comprises a groupcast, a multicast, or a broadcast message.

Aspect 4: The method of any of aspects 1 through 3, wherein the physical downlink control channel message is a first-stage physical downlink control channel message, and wherein the method further comprises: receiving, via the second radio, a second-stage physical downlink control channel message, wherein the second-stage physical downlink control channel message includes a scheduling grant that indicates a first set of resources associated with the data message, and wherein the data message is communicated via the first set of resources.

Aspect 5: The method of aspect 4, wherein the physical downlink control channel message includes an indication of a second set of resources associated with the second-stage physical downlink control channel message, and wherein the second-stage physical downlink control channel message is received via the second set of resources.

Aspect 6: The method of any of aspects 1 through 5, wherein the physical downlink control channel message includes a first scheduling grant that indicates a first set of resources associated with the data message, and wherein the data message is communicated via the first set of resources and the second radio.

Aspect 7: The method of aspect 6, wherein the physical downlink control channel message includes a second scheduling grant that indicates a second set of resources for transmission of a feedback message associated with reception of the physical downlink control channel message, and wherein the method further comprises: transmitting, to the second network entity, via the second set of resources and the second radio, and subsequent to reception of the physical downlink control channel message, the feedback message.

Aspect 8: The method of aspect 7, wherein, when the first scheduling grant is an uplink grant, the first set of resources indicated by the first scheduling grant and the second set of resources indicated by the second scheduling grant comprise a same set of resources, and wherein the method further comprises: participating in communication of the data message comprises transmission, to the second network entity and via the same set of resources, of a physical uplink shared channel message comprising the data message and the feedback message.

Aspect 9: The method of any of aspects 1 through 8, further comprising: decoding, with the first radio and based on detection of a layer-modulated signal, a first layer of the layer-modulated signal to detect a low-power wakeup signal; and decoding, with the first radio and based on an indication that the first network entity is associated with a sub-group associated with the low-power wakeup signal, a second layer of the layer-modulated signal to detect the physical downlink control channel message, wherein the second radio is switched to the on state further based on an indication that the physical downlink control channel message is directed to the first network entity.

Aspect 10: A method for wireless communication by a network entity, comprising: receiving, via a first radio, a low-power wakeup signal, wherein the first radio is limited with respect to a second radio, and wherein the second radio is in an off state; monitoring, based on detection of the low-power wakeup signal and via the first radio, for a physical downlink control channel message that is indicative that the network entity is to switch from use of the first radio to the second radio; and maintaining, based on an elapse of a predetermined time period without detection of the physical downlink control channel message, the second radio in the off state.

Aspect 11: The method of aspect 10, wherein the low-power wakeup signal is a sub-group common wakeup signal received at a plurality of network entities, wherein the plurality of network entities include the network entity, and wherein the physical downlink control channel message is specific to the network entity.

Aspect 12: The method of any of aspects 10 through 11, wherein the low-power wakeup signal is received during a first occasion, an wherein the physical downlink control channel message is received during a second occasion that is subsequent to the first occasion.

Aspect 13: The method of any of aspects 10 through 12, wherein the first radio is a LP-WUR of the network entity, and wherein the second radio is a main radio of the network entity.

Aspect 14: The method of any of aspects 10 through 13, wherein the network entity is a UE.

Aspect 15: A method for wireless communication by a first network entity for wireless communication, comprising: transmitting, to a target second network entity of a plurality of second network entities, a unicast physical downlink control channel message that is indicative that the target second network entity is to switch from use of a first radio to a second radio, wherein the first radio is limited with respect to the second radio; and scheduling a first set of resources for communication of a data message with the target second network entity.

Aspect 16: The method of aspect 15, wherein the unicast physical downlink control channel message is a low-power physical downlink control channel message.

Aspect 17: The method of any of aspects 15 through 16, further comprising: transmitting, to the plurality of second network entities and during a first occasion, a low-power wakeup signal, wherein the unicast physical downlink control channel message is transmitted based on transmission of the low-power wakeup signal and during a second occasion that is subsequent to the first occasion.

Aspect 18: The method of any of aspects 15 through 17, wherein the unicast physical downlink control channel message is a unicast first-stage physical downlink control channel message, and wherein the method further comprises: scheduling a second set of resources for transmission of a unicast second-stage physical downlink control channel message, wherein the unicast first-stage physical downlink control channel message includes an indication of the second set of resources; and transmitting, to the target second network entity and via the second set of resources, the unicast second-stage physical downlink control channel message, wherein the unicast second-stage physical downlink control channel message includes a scheduling grant that indicates the first set of resources for communication of the data message.

Aspect 19: The method of any of aspects 15 through 18, wherein the unicast physical downlink control channel message includes a first scheduling grant that indicates the first set of resources for communication of the data message.

Aspect 20: The method of aspect 19, wherein the unicast physical downlink control channel message is a unicast first-stage physical downlink control channel message, and wherein the unicast physical downlink control channel message includes a second scheduling grant that indicates a second set of resources for a feedback message associated with reception of the unicast first-stage physical downlink control channel message by the target second network entity.

Aspect 21: A first network entity for wireless communications, comprising one or more memories storing processor-executable code, and one or more processors coupled with the one or more memories and individually or collectively operable to execute the code to cause the first network entity to perform a method of any of aspects 1 through 9.

Aspect 22: A first network entity for wireless communications, comprising at least one means for performing a method of any of aspects 1 through 9.

Aspect 23: A non-transitory computer-readable medium storing code for wireless communications, the code comprising instructions executable by one or more processors to perform a method of any of aspects 1 through 9.

Aspect 24: A network entity for wireless communication, comprising one or more memories storing processor-executable code, and one or more processors coupled with the one or more memories and individually or collectively operable to execute the code to cause the network entity to perform a method of any of aspects 10 through 14.

Aspect 25: A network entity for wireless communication, comprising at least one means for performing a method of any of aspects 10 through 14.

Aspect 26: A non-transitory computer-readable medium storing code for wireless communication, the code comprising instructions executable by one or more processors to perform a method of any of aspects 10 through 14.

Aspect 27: A first network entity for wireless communication for wireless communication, comprising one or more memories storing processor-executable code, and one or more processors coupled with the one or more memories and individually or collectively operable to execute the code to cause the first network entity for wireless communication to perform a method of any of aspects 15 through 20.

Aspect 28: A first network entity for wireless communication for wireless communication, comprising at least one means for performing a method of any of aspects 15 through 20.

Aspect 29: A non-transitory computer-readable medium storing code for wireless communication, the code comprising instructions executable by one or more processors to perform a method of any of aspects 15 through 20.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other aspects and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration” and not “preferred” or “advantageous over other aspects.” The detailed description includes specific details for the purpose of providing an understanding of the described techniques. These techniques, however, may be practiced without these specific details. In some figures, structures and devices are shown in block diagram form in order to avoid obscuring the concepts of the described aspects.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the aspects and designs described herein but is to be accorded the broadest scope consistent with the principles and novel features disclosed herein.

What is claimed is:

1. A first network entity for wireless communications, comprising:
a processing system configured to:
receive, via a first radio, a physical downlink control channel message that is indicative that the first network entity is to switch from use of the first radio to a second radio, wherein the first radio is limited with respect to the second radio;
switch the second radio to an on state based on receipt, via the first radio, of the physical downlink control channel message; and
participate, after the switch, in communication of a data message with a second network entity via the second radio.

2. The first network entity of claim 1, wherein the processing system is configured to:
receive, via the first radio and during a first occasion, a low-power wakeup signal, wherein the physical downlink control channel message is received based on reception of the low-power wakeup signal and during a second occasion that is subsequent to the first occasion.

3. The first network entity of claim 2, wherein the low-power wakeup signal is a sub-group common wakeup signal received at a plurality of network entities, and
wherein the processing system is configured to:
monitor, via the second radio and based on detection of the low-power wakeup signal, for a second physical downlink control channel message comprising a groupcast, a multicast, or a broadcast message, wherein the second physical downlink control channel message includes a downlink scheduling grant that indicates a set of resources associated with a physical downlink shared channel message; and
receive, via the set of resources, the physical downlink shared channel message, wherein the physical downlink shared channel message comprises a groupcast, a multicast, or a broadcast message.

4. The first network entity of claim 1, wherein the physical downlink control channel message is a first-stage physical downlink control channel message, and
wherein the processing system is configured to:
receive, via the second radio, a second-stage physical downlink control channel message, wherein the second-stage physical downlink control channel message includes a scheduling grant that indicates a first set of resources associated with the data message, and wherein the data message is communicated via the first set of resources.

5. The first network entity of claim 4, wherein the physical downlink control channel message includes an indication of a second set of resources associated with the second-stage physical downlink control channel message, and
wherein the second-stage physical downlink control channel message is received via the second set of resources.

6. The first network entity of claim 1, wherein the physical downlink control channel message includes a first scheduling grant that indicates a first set of resources associated with the data message, and
wherein the data message is communicated via the first set of resources and the second radio.

7. The first network entity of claim 6, wherein the physical downlink control channel message includes a second scheduling grant that indicates a second set of resources for transmission of a feedback message associated with reception of the physical downlink control channel message, and
wherein the processing system is configured to:
transmit, to the second network entity, via the second set of resources and the second radio, and subsequent to reception of the physical downlink control channel message, the feedback message.

8. The first network entity of claim 7, wherein, when the first scheduling grant is an uplink grant, the first set of resources indicated by the first scheduling grant and the second set of resources indicated by the second scheduling grant comprise a same set of resources, and
wherein the processing system is configured to:
participate in communication of the data message comprises transmission, to the second network entity and via the same set of resources, of a physical uplink shared channel message comprising the data message and the feedback message.

9. The first network entity of claim 1, wherein the processing system is configured to:
decode, with the first radio and based on detection of a layer-modulated signal, a first layer of the layer-modulated signal to detect a low-power wakeup signal; and
decode, with the first radio and based on an indication that the first network entity is associated with a sub-group associated with the low-power wakeup signal, a second layer of the layer-modulated signal to detect the physical downlink control channel message, wherein the second radio is switched to the on state further based on an indication that the physical downlink control channel message is directed to the first network entity.

10. A network entity for wireless communication, comprising:
a processing system configured to:
receive, via a first radio, a low-power wakeup signal, wherein the first radio is limited with respect to a second radio, and wherein the second radio is in an off state;
monitor, based on detection of the low-power wakeup signal and via the first radio, for a physical downlink control channel message that is indicative that the network entity is to switch from use of the first radio to the second radio; and
maintain, based on an elapse of a predetermined time period without detection of the physical downlink control channel message, the second radio in the off state.

11. The network entity of claim 10, wherein the low-power wakeup signal is a sub-group common wakeup signal received at a plurality of network entities,
wherein the plurality of network entities include the network entity, and
wherein the physical downlink control channel message is specific to the network entity.

12. The network entity of claim 10, wherein the low-power wakeup signal is received during a first occasion, and
wherein the physical downlink control channel message is received during a second occasion that is subsequent to the first occasion.

13. The network entity of claim 10, wherein the first radio is a low-power wakeup receiver of the network entity, and
wherein the second radio is a main radio of the network entity.

14. The network entity of claim 10, wherein the network entity is a user equipment (UE).

15. A first network entity for wireless communication, comprising:
a processing system configured to:
transmit, to a target second network entity of a plurality of second network entities, a unicast physical downlink control channel message that is indicative that the target second network entity is to switch from use of a first radio to a second radio, wherein the first radio is limited with respect to the second radio; and
schedule a first set of resources for communication of a data message with the target second network entity.

16. The first network entity of claim 15, wherein the unicast physical downlink control channel message is a low-power physical downlink control channel message.

17. The first network entity of claim 15, wherein the processing system is configured to:
transmit, to the plurality of second network entities and during a first occasion, a low-power wakeup signal, wherein the unicast physical downlink control channel message is transmitted based on transmission of the low-power wakeup signal and during a second occasion that is subsequent to the first occasion.

18. The first network entity of claim 15, wherein the unicast physical downlink control channel message is a unicast first-stage physical downlink control channel message, and
wherein the processing system is configured to:
schedule a second set of resources for transmission of a unicast second-stage physical downlink control channel message, wherein the unicast first-stage physical downlink control channel message includes an indication of the second set of resources; and
transmit, to the target second network entity and via the second set of resources, the unicast second-stage physical downlink control channel message, wherein the unicast second-stage physical downlink control channel message includes a scheduling grant that indicates the first set of resources for communication of the data message.

19. The first network entity of claim 15, wherein the unicast physical downlink control channel message includes a first scheduling grant that indicates the first set of resources for communication of the data message.

20. The first network entity of claim 19, wherein the unicast physical downlink control channel message is a unicast first-stage physical downlink control channel message, and
wherein the unicast physical downlink control channel message includes a second scheduling grant that indicates a second set of resources for a feedback message associated with reception of the unicast first-stage physical downlink control channel message by the target second network entity.
